(19) United States
(12) Patent Application Publication
(10) Pub. No.: US 2023/0028863 A1
(43) Pub. Date: Jan. 26, 2023

(54) ANTI-GLARE SUBSTRATE FOR A DISPLAY ARTICLE WITH A TEXTURED REGION INCLUDING ONE OR MORE SURFACES AT TWO, THREE, OR FOUR ELEVATIONS, AND SURFACES FEATURES PROVIDING AT LEAST A PORTION OF THE ONE OR MORE SURFACES, AND METHOD OF MAKING THE SAME

(71) Applicant: CORNING INCORPORATED, Corning, NY (US)

(72) Inventors: Jiangwei Feng, Painted Post, NY (US); Corinne Elizabeth Isaac, Horseheads, NY (US); Karl William Koch, III, Elmira, NY (US); Shenping Li, Painted Post, NY (US); Wageesha Senaratne, Horseheads, NY (US); William Allen Wood, Painted Post, NY (US)

(21) Appl. No.: 17/852,467

(22) Filed: Jun. 29, 2022

Related U.S. Application Data
(60) Provisional application No. 63/218,567, filed on Jul. 6, 2021.

(51) Int. Cl. G02B 5/02

(52) U.S. Cl. CPC G02B 5/0294; G02B 5/0226

(57) ABSTRACT

A substrate for a display article is described herein including (a) a primary surface; and (b) a textured region disposed at the primary surface, the textured region comprising: (i) one or more higher surfaces residing at a higher mean elevation parallel to a base-plane disposed below the textured region extending through the substrate; (ii) one or more lower surfaces residing at a lower mean elevation parallel to the base-plane; and (iii) surface features providing at a least a portion of either or both of (i) the one or more higher surfaces and (ii) the one or more lower surfaces. The surface features can include larger surface features and smaller surface features, either or both providing one or more surfaces of the substrate that reside at one or more intermediate mean elevations parallel to the base-plane between the higher mean elevation and the lower mean elevation.

### CLAIM OF PRIORITY

This application claims the benefit of priority under 35 U.S.C. § 119 of U.S. Provisional Application No. 63/218,567, filed on Jul. 6, 2021, the contents of which are relied upon and incorporated herein by reference in their entirety.

### TECHNICAL FIELD

The present invention relates to an anti-glare substrate for a display article with a textured region including one or more surfaces at two, three, or four elevations, and surfaces features providing at least a portion of the one or more surfaces, and method of making the same.

### BACKGROUND

Substrates transparent to visible light are utilized to cover displays of display articles. Such display articles include smart phones, tablets, televisions, computer monitors, and the like. The displays are often liquid crystal displays and organic light emitting diodes, among others. The substrate protects the display, while the transparency of the substrate allows the user of the device to view the display.

The substrate reflecting ambient light, especially specular reflection, reduces the ability of the user to view the display through the substrate. Specular reflection in this context is the mirror-like reflection of ambient light off the substrate. For example, the substrate may reflect visible light reflecting off or emitted by an object in the environment around the device. The visible light reflecting off the substrate reduces the contrast of the light from the display transmitting to the eyes of the user through the substrate. At some viewing angles, instead of seeing the visible light that the display emits, the user sees a specularly reflected image. Thus, attempts have been made to reduce specular reflection of visible ambient light off the substrate.

Attempts have been made to reduce specular reflection off the substrate by texturing the reflecting surface of the substrate. The resulting surface is sometimes referred to as an “antiglare surface.” For example, sandblasting and liquid etching the surface of the substrate can texture the surface, which generally causes the surface to reflect ambient light diffusely rather than specularly. Diffuse reflection generally means that the surface still reflects the same ambient light but the texture of the reflecting surface scatters the light upon reflection. The more diffuse reflection interferes less with the ability of the user to seethe visible light that the display emits.

Such methods of texturing (i.e., sandblasting and liquid etching) generate features on the surface with imprecise and unrepeatable geometry (the features provide the texture). The geometry of the textured surface of one substrate formed via sandblasting or liquid etching can never be exactly the same as the geometry of the textured surface of another substrate formed via sandblasting or liquid etching. Commonly, only a quantification of the surface roughness (i.e., Rₐ) of the textured surface of the substrate is a repeatable target of the texturing.

There are a variety of metrics by which the quality of the “antiglare” surface is judged. Those metrics include (1) the distinctness-of-image, (2) pixel power deviation, (3) apparent Moiré interference fringes, (4) transmission haze, and (5) reflection color artifacts. Distinctness-of-image, which more aptly might be referred to as distinctness-of-reflected-image, is a measure of how distinct an image reflecting off the surface appears. The lower the distinctness-of-image, the more the textured surface is diffusely reflecting rather than specularly reflecting. Surface features can magnify various pixels of the display, which distorts the image that the user views. Pixel power deviation, also referred to as “sparkle,” is a quantification of such an effect. The lower the pixel power deviation the better. Moiré interference fringes are large-scale interference patterns, which, if visible, distort the image that the user sees. Preferably, the textured surface produces no apparent Moiré interference fringes. Transmission haze is a measure of how much the textured surface is diffusing the visible light that the display emitted upon transmitting through the substrate. The greater the transmission haze, the less sharp the display appears (i.e., lowered apparent resolution). Reflection color artifacts are a sort of chromatic aberration where the textured surface diffracts light upon reflection as a function of wavelength—meaning that the reflected light, although relatively diffuse, appears segmented by color. The less reflected color artifacts that the textured surface produces the better. All of these attributes are discussed in greater detail below.

Targeting a specific surface roughness cannot optimize all those metrics simultaneously. A relatively high surface roughness that sandblasting or liquid etching produces might adequately transform specular reflection into diffuse reflection. However, the high surface roughness can additionally generate high transmission haze and pixel power deviation. A relatively low surface roughness, while decreasing transmission haze, might fail to sufficiently transform specular reflection into diffuse reflection—defeating the “antiglare” purpose of the texturing.

Accordingly, a new approach to providing a textured region of the substrate is needed-one that causes the textured surface to reflect ambient light sufficiently diffusely rather than specularly so as to be “antiglare” (e.g., a low distinctness-of-image), but simultaneously also delivers low pixel power deviation, no apparent Moiré interference fringes, low transmission haze, and low reflection color artifacts.

### SUMMARY

The present disclosure addresses that need with substrate including a textured surface having two, three, or four mean elevations, and surface features that are specifically placed but randomly distributed. The separation between the elevations are determined by the period of time that the substrate is contacted with an etchant in a first etching step providing two elevations and optionally a second etching step that provide either one or two more elevations to the textured region. The etching steps form the surface features. The specificity of the placement of the surface features and etching time allows the geometry of the textured region to be repeated from one substrate to another substrate, something that sandblasting or liquid etching alone cannot achieve. The random distribution of the surface features avoids adverse visual consequences, such as Moiré interference fringes, that could result if the placement of the surface features were part of a pattern. The use of an etching mask allows a liquid etching step to precisely form the surface features in their specific placement. A spacing distribution algorithm can be utilized to determine the specific placement of the surface features according to a random distribution and that placement is adopted in the formation of an etching mask. An etching step using that etching mask generates the surface features, each specifically placed.

Each surface feature can have a defined geometry, such as diameter and minimum center-to-center spacing. Thus, this approach provides the designer of the textured region with a variety of variables that can be manipulated (rather than just one variable in surface roughness) to optimize the antiglare metrics of the substrate. In addition, the selection of those variables and placement of the surface features can now be repeated from one substrate to another substrate.

According to a first aspect of the present disclosure, a substrate for a display article, the substrate comprises: (a) a primary surface; and (b) a textured region defined on the primary surface, the textured region comprising: (i) one or more higher surfaces residing at a higher mean elevation parallel to a base-plane disposed below the textured region extending through the substrate; (ii) one or more lower surfaces residing at a lower mean elevation parallel to the base-plane, wherein the lower mean elevation is less than the higher mean elevation; and (iii) surface features providing at a least a portion of either the one or more higher surfaces residing at the higher mean elevation or the one or more lower surfaces residing at the lower mean elevation, each surface feature comprising a perimeter that is parallel to the base-plane and that has a longest dimension.

According to a second aspect of the present disclosure, the substrate of the first aspect, wherein the lower mean elevation differs from the higher mean elevation by a distance within a range of 50 nm to 700 nm.

According to a third aspect of the present disclosure, the substrate of any one of the first through second aspects is presented, wherein the longest dimensions of the surface features are within a range of 0.5 μm to 120 μm.

According to a fourth aspect of the present disclosure, the substrate of any one of the first through third aspects is presented, wherein the surface features are not arranged in a pattern.

According to a fifth aspect of the present disclosure, the substrate of any one of the first through fourth aspects is presented, (a) wherein the textured region further comprises: a surrounding portion providing either (i) the one or more higher surfaces or (ii) the one or more lower surfaces; (b) wherein, the surface features provide the other of the (i) the one or more higher surfaces and (ii) the one or more lower surfaces, whichever the surrounding portion is not providing.

According to a sixth aspect of the present disclosure, the substrate of the fifth aspect is presented, wherein (i) the surface features are disposed within the surrounding portion, and provide the one or more lower surfaces; and (ii) the surrounding portion provides the one or more higher surfaces.

According to a seventh aspect of the present disclosure, the substrate of the fifth aspect is presented, wherein (i) the surface features project from the surrounding portion, and provide the one or more higher surfaces of the substrate residing at the higher mean elevation; and (ii) the surrounding portion provides the one or more lower surfaces of the substrate residing at the lower mean elevation.

According to an eighth aspect of the present disclosure, the substrate of any one of the first through seventh aspects, wherein a fill-fraction of the surface features is within a range of 40% to 60%.

According to a ninth aspect of the present disclosure, the substrate of any one of the first through eighth aspects, wherein (i) the surface features comprise larger surface features and smaller surface features, (ii) the longest dimension of the larger surface features are all about the same and are within a range of 30 μm to 120 μm, (iii) the longest dimension of the smaller surface features are all about the same, are smaller than the longest dimension of the larger surface features, and are within a range of 0.5 μm to 30 μm, and (iv) the smaller surface features are more numerous than the larger surface features.

According to a tenth aspect of the present disclosure, the substrate of the ninth aspect is presented, wherein (i) each of the larger surface features are separated from each other by a minimum center-to-center distance that (i) is larger than the longest dimension of the larger surface features and (ii) within a range of 30 μm to 125 μm; and (ii) each of the smaller surface features are separated by a minimum center-to-center distance that (i) is larger than the longest dimension of the smaller surface features and (ii) within a range of 1 μm to 30 μm.

According to an eleventh aspect of the present disclosure, the substrate of any one of the ninth through tenth aspects, wherein the smaller surface features provide a portion of both (i) the one or more higher surfaces and (ii) the one or more lower surfaces.

According to a twelfth aspect of the present disclosure, the substrate of any one of the ninth through eleventh aspects, wherein the perimeters of the larger surface features do not overlap with the perimeters of the smaller surface features.

According to a thirteenth aspect of the present disclosure, the substrate of any one of the ninth through eleventh aspects, wherein the perimeters of the larger surface features overlap with the perimeters of the smaller surface features.

According to a fourteenth aspect of the present disclosure, the substrate of any one of the ninth through thirteenth aspects, wherein (i) a fill-fraction of the larger surface features is 20% to 70%; and (ii) a fill-fraction of the smaller surface features is within a range of 20% to 70%.

According to a fifteenth aspect of the present disclosure, the substrate of any one of the ninth through fourteenth aspects, wherein (i) the textured region exhibits a transmission haze within a range of 0.5% to 10%; (ii) the textured region exhibits a pixel power deviation within a range of 1.2% to 5.0%; the textured region exhibits a distinctness-of-image within a range of 40% to 100%; and (iv) the textured region exhibits corrected color shifts ΔC_{x_corrected} and ΔC_{y_corrected} that are each respectively within a range of 0.001 to 4.0.

According to a sixteenth aspect of the present disclosure, the substrate of any one of the first through fifteenth aspects, wherein the textured region further comprises one or more sections comprising secondary surface features imparting a surface roughness (Rₐ) within a range of 5 nm to 100 nm.

According to a seventeenth aspect of the present disclosure, the substrate of any one of the first through sixteenth aspects, wherein the perimeter of each of the surface features is circular, and the longest dimension is the diameter.

According to an eighteenth aspect of the present disclosure, the substrate of any one of the first through seventeenth aspects, wherein the substrate comprises a glass substrate or a glass-ceramic substrate.

According to a nineteenth aspect of the present disclosure, a substrate for a display article, the substrate comprising: (I) a primary surface; and (II) a textured region defined on the primary surface, the textured region comprising: (a) one or more higher surfaces of a substrate residing at a higher mean elevation parallel to a base-plane disposed below the textured region extending through the substrate; (b) one or more lower surfaces of the substrate residing at a lower mean elevation parallel to the base-plane, wherein the lower mean elevation is less than the higher mean elevation; (c) one or more surfaces of the substrate residing at one or more intermediate mean elevations parallel to the base-plane, wherein the one or more intermediate mean elevations are less than the higher mean elevation but greater than the lower mean elevation; and (d) surface features providing at a least a portion of (i) the one or more higher surfaces residing at the higher mean elevation, (ii) the one or more lower surfaces residing at the lower mean elevation, or (iii) the one or more surfaces of the substrate residing at one or more intermediate mean elevations, wherein, each surface feature comprises a perimeter and has a longest dimension parallel to the base-plane, wherein, the surface features comprise larger surface features and smaller surface features, and wherein, the longest dimensions of the smaller surface features are smaller than the longest dimensions of the larger surface features.

According to a twentieth aspect of the present disclosure, the substrate of the nineteenth aspect, wherein (i) the textured region comprises only one intermediate mean elevation; (ii) the intermediate mean elevation is less than the higher mean elevation by a distance within a range of 100 nm to 250 nm; and (iii) the lower mean elevation is less than the higher mean elevation by a distance within a range of 250 nm to 500 nm.

According to a twenty-first aspect of the present disclosure, the substrate of the nineteenth aspect, wherein (i) there are two intermediate mean elevations; (ii) the more elevated of the two intermediate mean elevations is less than the higher mean elevation by a distance within a range of 100 nm to 200 nm; (iii) the less elevated of the intermediate mean elevations is less than the higher mean elevation by a distance within a range of 200 nm to 300 nm; and (iv) the lower mean elevation is less than the higher mean elevation by a distance within a range of 300 nm to 500 nm.

According to a twenty-second aspect of the present disclosure, the substrate of any one of the nineteenth through twenty-first aspects, wherein (i) the longest dimension of the larger surface features are within a range of 30 μm to 120 μm, (ii) the longest dimension of the smaller surface features are within a range of 0.5 μm to 30 μm, and (iii) the smaller surface features are more numerous than the larger surface features.

According to a twenty-third aspect of the present disclosure, the substrate of any one of the nineteenth through twenty-second aspects, wherein (i) each of the larger surface features are separated by a minimum center-to-center distance that (i) is larger than the longest dimension of the larger surface features and (ii) within a range of 30 μm to 125 μm; and (ii) each of the smaller surface features are separated by a minimum center-to-center distance that (i) is larger than the longest dimension of the smaller surface features and (ii) within a range of 1 μm to 30 μm.

According to a twenty-fourth aspect of the present disclosure, the substrate of any one of the nineteenth through twenty-third aspects, wherein (i) a fill-fraction of the larger surface features is 20% to 70%; and (ii) a fill-fraction of the smaller surface features is within a range of 20% to 70%.

According to a twenty-fifth aspect of the present disclosure, the substrate of any one of the nineteenth through twenty-fourth aspects, wherein (i) the textured region exhibits a transmission haze within a range of 1.9% to 35%; (ii) the textured region exhibits a pixel power deviation within a range of 1.0% to 9.0%; (iii) the textured region exhibits a distinctness-of-image within a range of 10% to 100%; and (iv) the textured region exhibits corrected color shifts ΔC_{x_corrected} and ΔC_{y_corrected} that are each respectively within a range of 0.001 to 1.5.

According to a twenty-sixth aspect of the present disclosure, the substrate of any one of the nineteenth through twenty-fifth aspects, wherein one or more sections comprising secondary surface features imparting a surface roughness (Rₐ) within a range of 5 nm to 100 nm.

According to a twenty-seventh aspect of the present disclosure, the substrate of anyone of the nineteenth through twenty-sixth aspects, wherein the perimeter of each of the surface features is circular, and the longest dimension is the diameter.

According to a twenty-eighth aspect of the present disclosure, the substrate of the twenty-seventh aspect, wherein (i) the diameters of smaller surface features are all about the same; and (ii) the diameters of the larger surface features are all about the same.

According to a twenty-ninth aspect of the present disclosure, the substrate of any one of the nineteenth through twenty-eighth aspects, wherein the substrate comprises a glass substrate or a glass-ceramic substrate.

According to a thirtieth aspect of the present disclosure, a substrate for a display article, the substrate comprising: (I) a primary surface; a textured region defined on the primary surface, the textured region comprising: (a) one or more higher surfaces residing at a higher mean elevation parallel to a base-plane disposed below the textured region and extending through the substrate; (b) one or more lower surfaces residing at a lower mean elevation parallel to the base-plane, wherein the lower mean elevation is less than the higher mean elevation; (c) a surrounding portion providing either (i) the one or more higher surfaces residing at the higher mean elevation or (ii) the one or more lower surfaces of the substrate residing at the lower mean elevation; and (d) surface features, each having a perimeter that is parallel to the base-plane, projecting out of or disposed with a surrounding portion, wherein each surface feature comprises a longest dimension from a fixed set of longest dimensions ranging from a smallest longest dimension to a largest longest dimension.

According to a thirty-first aspect of the present disclosure, the substrate of the thirtieth aspect, wherein a minimum center-to-center distance separates each of the surface features with the largest diameter.

According to a thirty-second aspect of the present disclosure, the substrate of any one of the thirtieth through thirty-first aspects, wherein the surface features with the largest longest dimension are not arranged in a pattern.

According to a thirty-third aspect of the present disclosure, the substrate of any one of the thirtieth through thirty-second aspects, wherein the fixed set of longest dimensions consist of three, four, or five longest dimensions.

According to a thirty-fourth aspect of the present disclosure, the substrate of any one of the thirtieth through thirty-third aspects, wherein the longest dimensions of all of the fixed set of longest dimensions lie within a range of 0.5 μm to 120 μm.

According to a thirty-fifth aspect of the present disclosure, the substrate of anyone of the thirtieth through thirty-fourth aspects, wherein (i) the textured region exhibits a transmission haze within a range of 2.0% to 20%; (ii) the textured region exhibits a pixel power deviation within a range of 1.0% to 5.0%; (iii) the textured region exhibits a distinctness-of-image within a range of 50% to 100%; and (iv) the textured region exhibits corrected color shifts ΔC_{x_corrected} and ΔC_{y_corrected} that are each respectively within a range of 0.001 to 0.30.

According to a thirty-sixth aspect of the present disclosure, the substrate of any one of the thirtieth through thirty-fifth aspects, wherein the higher mean elevation differs from the lower mean elevation by a distance within a range of 50 nm to 700 nm.

According to a thirty-seventh aspect of the present disclosure, the substrate of any one of the thirtieth through thirty-sixth aspects, wherein the textured region further comprises one or more sections comprising secondary surface features imparting a surface roughness (Rₐ) within a range of 5 nm to 100 nm.

According to a thirty-eighth aspect of the present disclosure, the substrate of any one of the thirtieth through thirty-seventh aspects, wherein the perimeter of each of the surface features is circular, and the longest dimension is the diameter.

According to a thirty-ninth aspect of the present disclosure, the substrate of any one of the thirtieth through thirty-eighth aspects, wherein a fill-fraction of the surface features is 40% to 60%.

According to a fortieth aspect of the present disclosure, the substrate of any one of the thirtieth through thirty-ninth aspects, wherein the substrate comprises a glass substrate or a glass-ceramic substrate.

According to a forty-first aspect of the present disclosure, a method of forming a textured region of a substrate fora display article, the method comprising: (a) determining the positioning of surface features, each surface feature comprising a perimeter, thus establishing the predetermined positioning of each surface feature; (b) disposing an etching mask on a primary surface of a substrate that either (i) prevents etching where the surface features are to be formed in accordance with the predetermined positioning of the surface features or (ii) allows etching only where the surface features are to be formed in accordance with the predetermined positioning of the surface features; and (c) contacting the substrate with an etchant for a period of time while the etching mask is disposed on the primary surface of the substrate, thus forming a textured region defined on the primary surface comprising (i) one or more higher surfaces of the substrate residing at a higher mean elevation parallel to a base-plane disposed below the textured region and extending through the substrate, (ii) one or more lower surfaces of the substrate residing at a lower mean elevation parallel to the base-plane, wherein the lower mean elevation is less than the higher mean elevation, and (iii) the surface features.

According to a forty-second aspect of the present disclosure, the method of the forty-first aspect further comprises: (a) determining the positioning of smaller surface features, each smaller surface comprising a perimeter, thus establishing the predetermined positioning of each the smaller surface feature, wherein the perimeter of the smaller surface features are smaller than the perimeter of the larger surface features; (b) disposing a second etching mask on the textured region of the substrate that either (i) prevents etching where the smaller surface features are to be formed in accordance with the predetermined positioning of the smaller surface features or (ii) allows etching only where the smaller surface features are to be formed in accordance with the predetermined positioning of the smaller surface features; and (c) contacting the substrate with an etchant for a period of time while the second etching mask is disposed on the textured region of the substrate, thus modifying the textured region to further comprise (i) one or more surfaces of the substrate residing at one or more intermediate mean elevations parallel to the base-plane, wherein the one or more intermediate mean elevations are less than the higher mean elevation but greater than the lower mean elevation, and (ii) the smaller surface features.

According to a forty-third aspect of the present disclosure, the method of any one of the forty-first through forty-second aspects further comprises: forming secondary surface features into one or more sections of the textured region, thereby increasing the surface roughness (Rₐ) of at the one or more sections to within a range of 5 nm to 100 nm.

According to a forty-fourth aspect of the present disclosure, the method of any one of the forty-first through forty-third aspects, wherein (i) the perimeter of each of the surface features is circular, and (ii) the perimeter of each of the smaller surface features is circular.

### BRIEF DESCRIPTION OF THE DRAWINGS

In the figures:

FIG. 1 is a perspective view of a display article of the present disclosure, illustrating a substrate including a textured region;

FIG. 2 is a height profile of embodiments of the textured region of FIG. 1, illustrating larger surface features, smaller surface features, and a surrounding portion providing surfaces that reside at four different mean elevations from a base-plane disposed below the textured region;

FIG. 3 is an elevational view of a cross-section of the height profile of FIG. 2 taken through line III-III of FIG. 2, illustrating the textured region residing at the four different mean elevations above the base-plane;

FIG. 4 is a height profile of embodiments of the textured region of FIG. 1, illustrating (i) larger surface features and smaller surface features both projecting from the surrounding portion, (ii) the illustrating larger surface features, smaller surface features, and the surrounding portion providing surfaces that reside at two mean elevations—a higher mean elevation and a lower mean elevation, and (iii) none of the smaller surface features only partially overlapping with any of the larger surface features;

FIG. 5 is a relative height diagram of embodiments of the textured region of FIG. 1, like FIG. 4, but illustrating some of the smaller surface features partially overlapping with some of the larger surface features, resulting in those overlapping smaller surface features providing surfaces at both the higher mean elevation and the lower mean elevation;

FIG. 6 is a schematic diagram of embodiments of the textured region of FIG. 1, illustrating the larger surface features and the smaller surface features either both projecting from the surrounding portion or both set into the surrounding portion;

FIG. 7 is a height profile of embodiments of the textured region of FIG. 1, illustrating (i) the larger surface features projecting from the surrounding portion, (ii) the smaller surface features projecting from both the surrounding portion and the larger surface features, (iii) some of the smaller surface features overlapping with some of the larger surface features, and (iv) the larger surface features, the smaller surface features, and the surrounding portion providing surfaces that reside at four different mean elevations from a base-plane disposed below the textured region;

FIG. 8A is a schematic diagram of embodiments of the textured region of FIG. 1, illustrating the surface features either projecting from or set into the surrounding portion, and each of the surface features having a diameter from a fixed set of three diameters;

FIG. 8B is a schematic diagram of embodiments of the textured region of FIG. 1, illustrating the surface features either projecting from or set into the surrounding portion, and the surface features having a diameter from a fixed set of four diameters;

FIG. 8C is a schematic diagram of embodiments of the textured region of FIG. 1, illustrating the surface features either projecting from or set into the surrounding portion, and the surface features having a diameter from a fixed set of five diameters;

FIG. 9 is a schematic diagram of embodiments of the textured region of FIG. 1 and a line profile extracted along the dashed line, illustrating that the surfaces providing the higher elevation and the surfaces providing the lower elevation are planar, and further that sidewalls transitioning from the surfaces providing the lower elevation to the surfaces providing the higher elevation for an approximately right angle;

FIG. 10 is a schematic view of a testing set up to determine color shift present in light that the textured region of FIG. 1 reflects;

FIG. 11 is a schematic diagram of a method of forming the textured region of FIG. 1;

FIG. 12, pertaining to Examples 1A and 1B, reproduces histograms of the nearest neighbor distance for objects randomly distributed pursuant to two different spacing distribution algorithms—a Poisson disk distribution algorithm (on the left) and a maxi-min spacing algorithm (on the right);

FIG. 13A, pertaining to Example 2A and Comparative Example 2B, is a graph of pixel power deviation as a function of the depth of the larger surface features from the surrounding portion, illustrating that the presence of the smaller surface features in Example 2A results in a lower pixel power deviation than Comparative Example 2B, which lacked such smaller surface features;

FIG. 13B, again pertaining to Example 2A and Comparative Example 2B, is a graph of distinctness-of-image as a function of the depth of the larger surface features from the surrounding portion, illustrating that the presence of the smaller surface features in Example 2A generally resulted in a lower distinctness-of-image than Comparative Example 2B, which lacked such smaller surface features;

FIG. 14A, pertaining to Example 11A, is an image of a scattered light pattern that embodiments of the textured region of FIG. 1 generated;

FIG. 148, pertaining to Example 11A, is a graph plotting intensity as a function of pixel position in the image of FIG. 14A for the colors red, blue, and green;

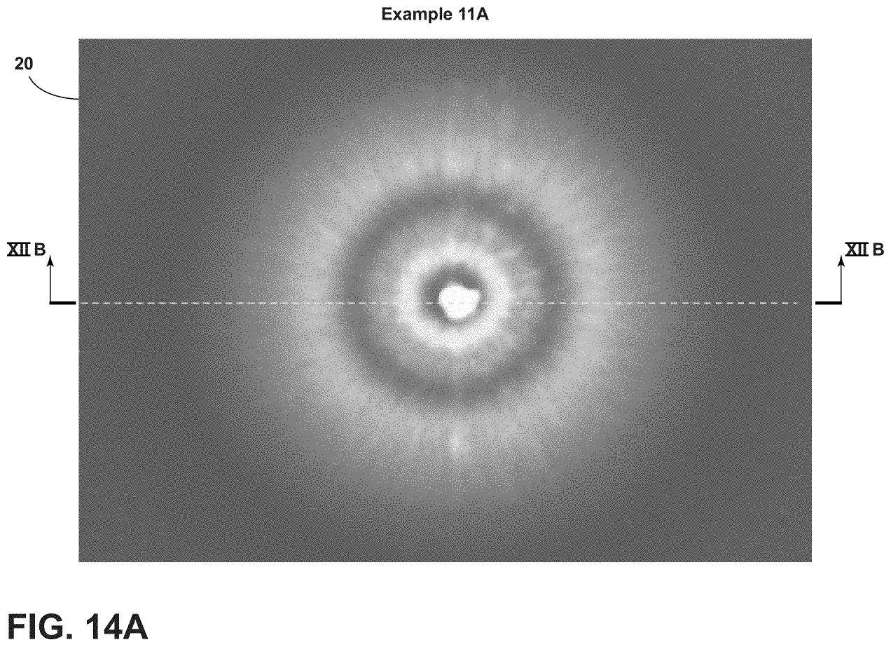

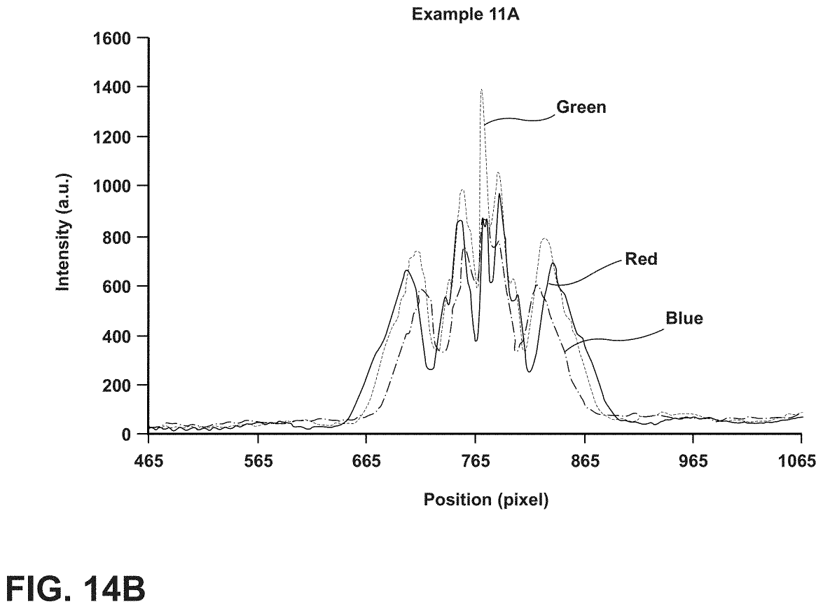

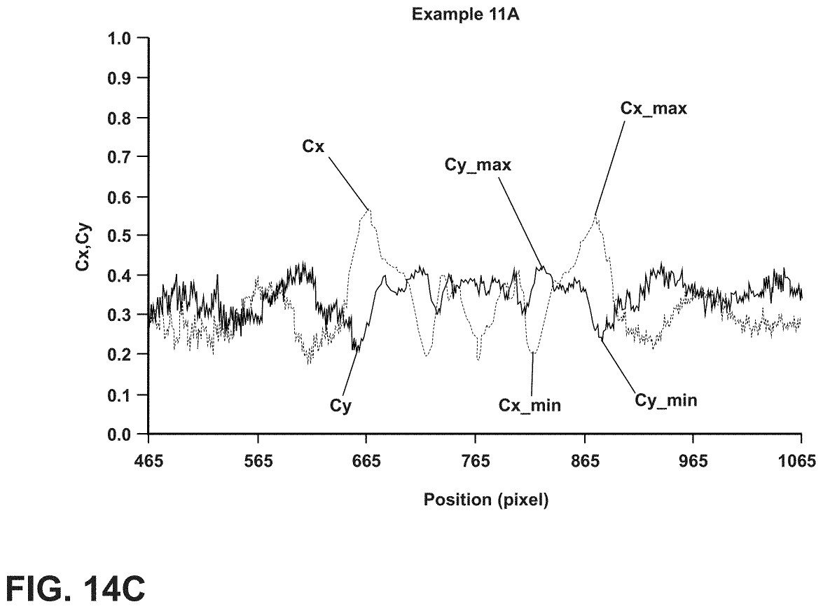

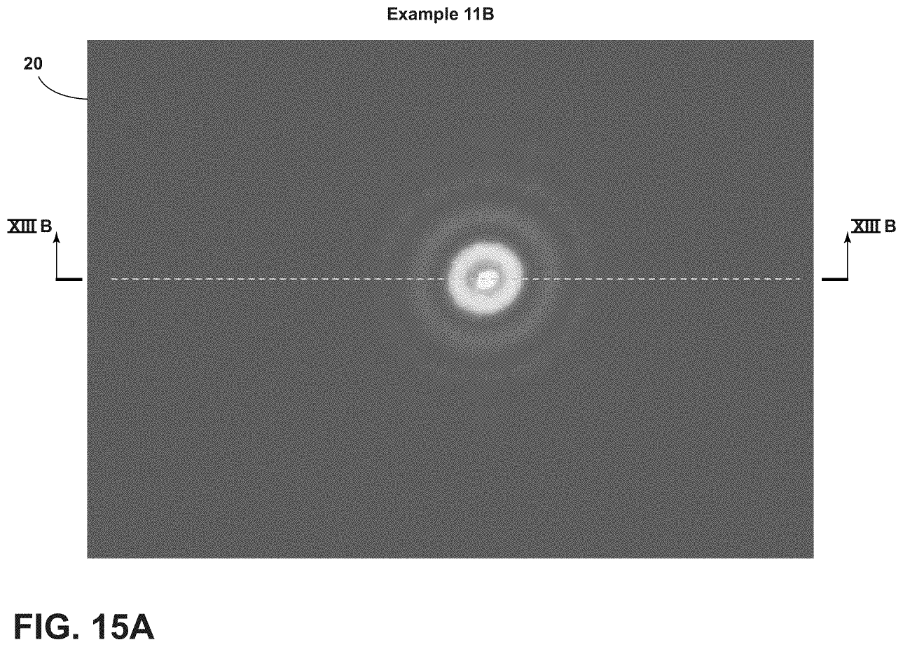

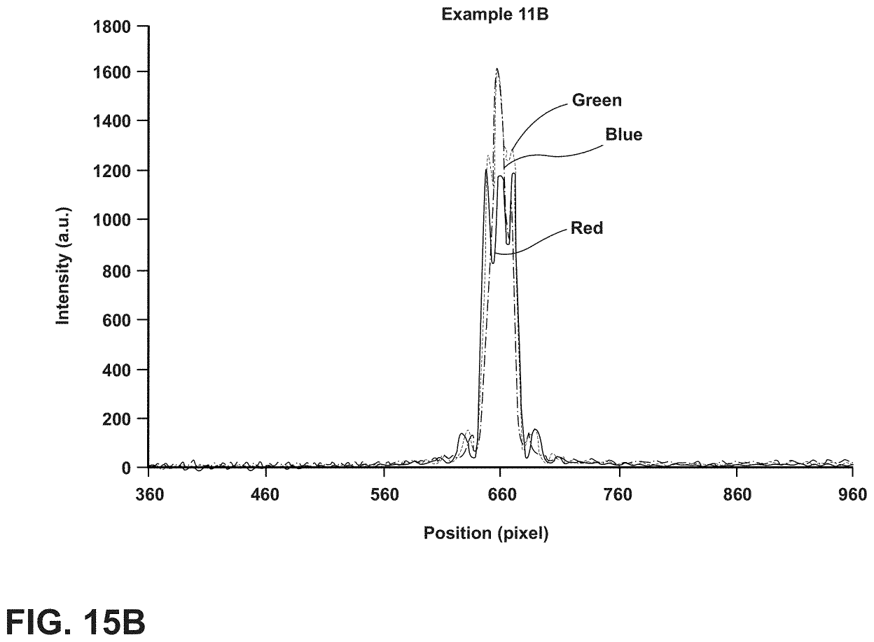

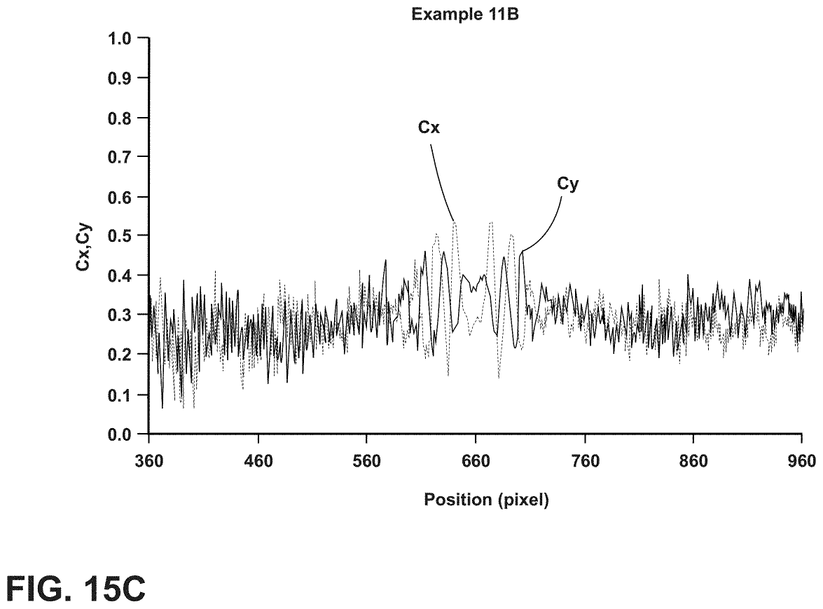

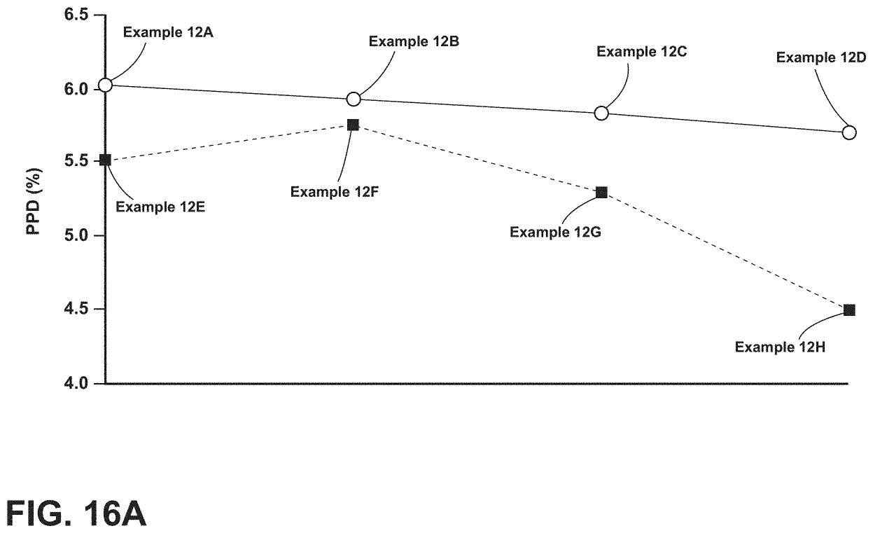

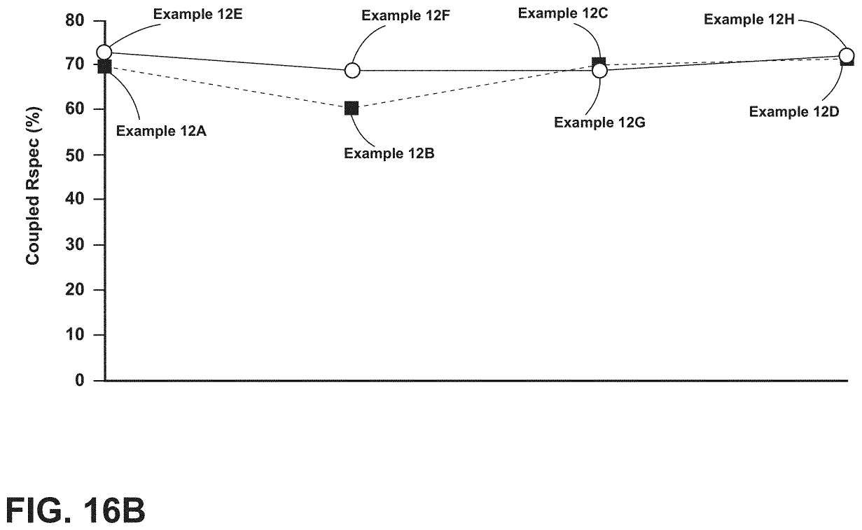

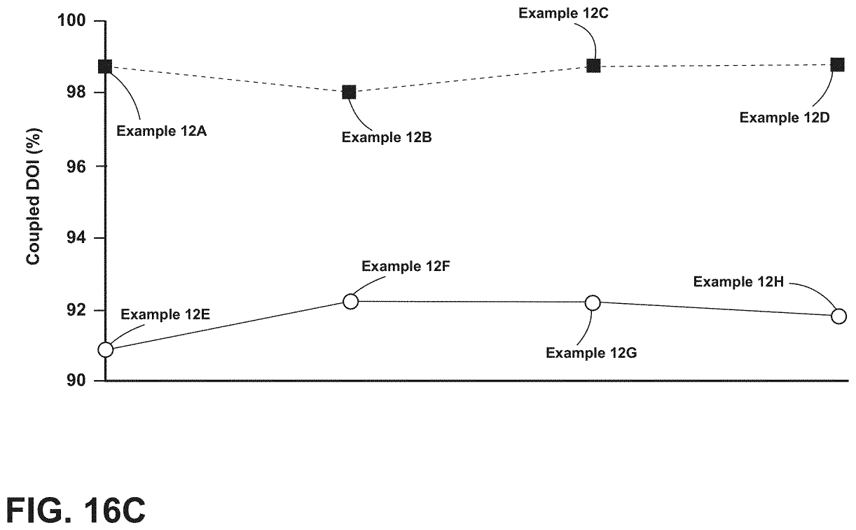

FIG. 14C, pertaining to Example 11A, is a graph plotting color chromaticity as a function of pixel position in the image of FIG. 14A for Cₓ and C_{y};

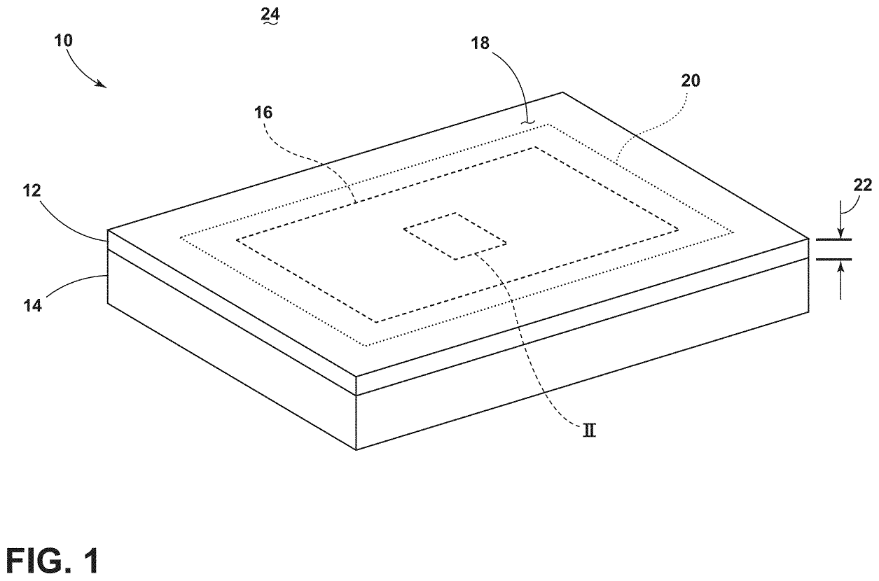

FIG. 15A, pertaining to Example 11B, is an image of a scattered light pattern that embodiments of the textured region of FIG. 1 generated;

FIG. 15B, pertaining to Example 11B, is a graph plotting intensity as a function of pixel position in the image of FIG. 14A for the colors red, blue, and green;

FIG. 15C, pertaining to Example 11A, is a graph plotting color chromaticity as a function of pixel position in the image of FIG. 15A for Cₓ and C_{y};

FIG. 16A, pertaining to Examples 12A-12H, is a graph that illustrates that the inclusion of the secondary surface features results in a lower pixel power deviation and, further, that the resulting pixel power deviation can vary depending on the surface roughness (Rₐ) that the secondary surface features imparted, and thus the composition of the etchant used to form the secondary surface features;

FIG. 16B, pertaining to Examples 12A-12H, is a graph that illustrates that the presence of the secondary surface features did not change measured specular reflectance compared to substrates that did not have the secondary surface features;

FIG. 16C, pertaining to Examples 12A-12H, is a graph that illustrates that the presence of the secondary surface features produces a lower distinctness-of-image compared to substrates that did not have the secondary surface features; and

FIG. 16D, pertaining to Examples 12A-12H, is a graph that illustrates that the presence of the secondary surface features produces greater transmission haze compared to substrates that did not have the secondary surface features, and increasingly so as the surface roughness (Rₐ) that the secondary surface features imparts increases.

### DETAILED DESCRIPTION

Referring now to FIG. 1, a display article 10 includes a substrate 12. In embodiments, the display article 10 further includes a housing 14 to which the substrate 12 is coupled and a display 16 within the housing 14. In such embodiments, the substrate 12 at least partially covers the display 16 such that light that the display 16 emits can transmit through the substrate 12.

The substrate 12 includes a primary surface 18, a textured region 20 defined on the primary surface 18, and a thickness 22 that the primary surface 18 bounds in part. The primary surface 18 generally faces toward an external environment 24 surrounding the display article 10 and away from the display 16. The display 16 emits visible light that transmits through the thickness 22 of the substrate 12, out the primary surface 18, and into the external environment 24.

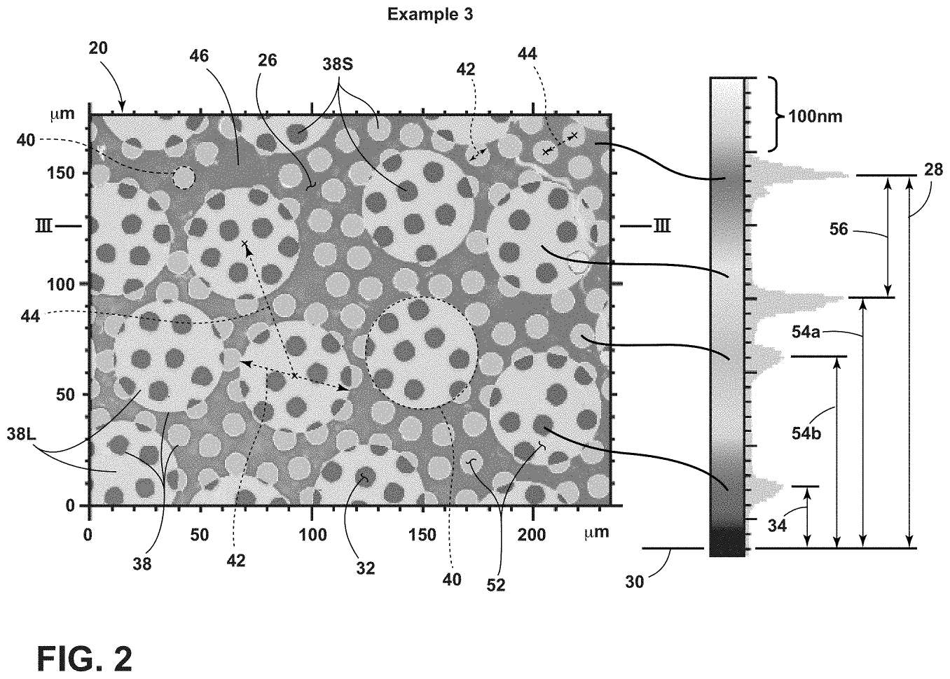

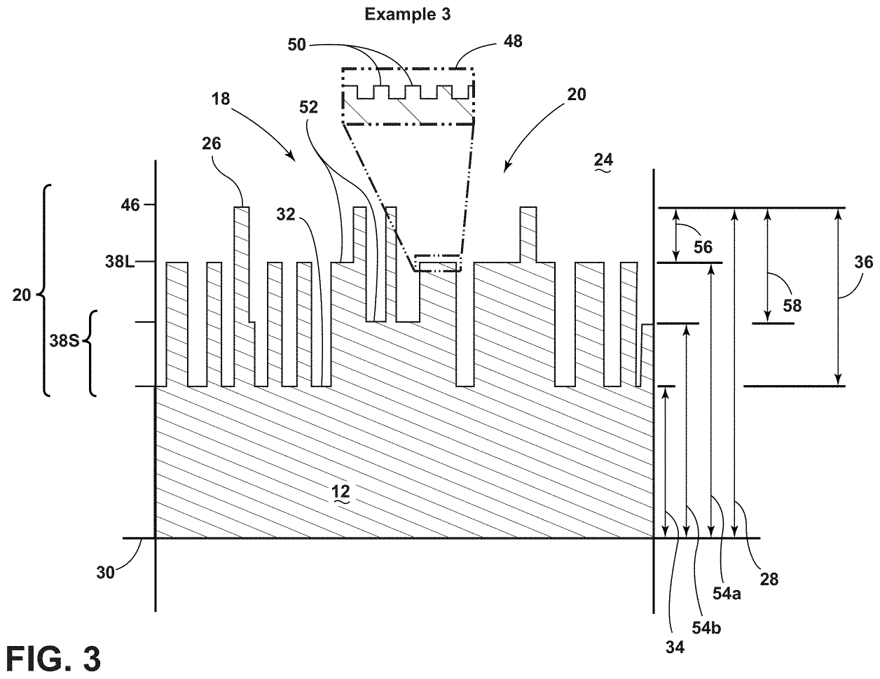

Referring now to FIGS. 2-7, in embodiments, the textured region 20 includes one or more higher surfaces 26. The one or more higher surfaces 26 reside at a higher mean elevation 28. The higher mean elevation 28 is parallel to a base-plane 30 that extends through the thickness 22 beneath the textured region 20 and parallel to the primary surface 18. The base-plane 30 is conceptual not structural. The base-plane 30 provides a reference by which the higher mean elevation 28, and the other elevations mentioned herein can be determined, relative to the base-plane 30 and thus each other. The one or more higher surfaces 26 are planar within manufacturing tolerances.

The textured region 20 further includes one or more lower surfaces 32. The one or more lower surfaces 32 reside at a lower mean elevation 34. The lower mean elevation 34 is also parallel to the base-plane 30. The lower mean elevation 34 is less than the higher mean elevation 28. The one or more lower surfaces 32 are planar within manufacturing tolerances. The lower mean elevation 34 differs from the higher mean elevation 28 by a distance 36. In embodiments, the distance 36 is 50 nm, 100 nm, 150 nm, 200 nm, 250 nm, 300 nm, 350 nm, 400 nm, 450 nm, 500 nm, 550 nm, 600 nm, 650 nm, 700 nm, or within any range defined by any two of those values (e.g., 50 nm to 700 nm, 100 nm to 400 nm, and so on). “Higher” of the higher mean elevation 28 and the “lower” of lower mean elevation 34 are relative terms simply meaning that the higher mean elevation 28 is more elevated from the base-plane 30 than the lower mean elevation 34. Each of the one or more lower surfaces 32 resides at the lower mean elevation 34, within manufacturing tolerances. Each of the one or more higher surfaces 26 resides at the higher mean elevation 28, within manufacturing tolerances.

The textured region 20 further includes surface features 38. Each surface feature 38 includes a perimeter 40. The perimeter 40 is parallel to the base-plane 30. The perimeter 40 has a longest dimension 42. The perimeter 40 can have a characteristic shape, such as an ellipsis, a circle, a hexagon, and so on. In embodiments, the perimeter 40 of each surface feature 38 is circular and the longest dimension 42 is a diameter of the perimeter 40. Each surface feature 38 provides at least a portion of either the one or more higher surfaces 26 residing at the higher mean elevation 28 or the one or more lower surfaces 32 residing at the lower mean elevation 34. In embodiments, the longest dimensions 42 of the surface features 38 is 0.5 μm, 1.0 μm, 5.0 μm, 10 μm, 20 μm, 30 μm, 40 μm, 50 μm, 60 μm, 70 μm, 80 μm, 90 μm, 100 μm, 110 μm, 120 μm, or within any range bound by any two of those values (e.g., 0.5 μm to 120 μm, and so on).

In embodiments, the perimeters 40 of the surface features 38 do not overlap and are separated by a minimum center-to-center distance 44. The minimum center-to-center 44 distance in such embodiments is greater than the diameter longest dimension 42 of the surface features 38. For example, if the minimum center-to-center distance 44 separating the surface features 38 is 60 μm, then no two of the surface features 38 are separated, center-to-center, by less than 60 μm. The center-to-center distance separating any two of the surface features 38 may be 60 μm or more than 60 μm but not less than 60 μm.

In embodiments, the surface features 38 are arranged in a pattern. A pattern means, for purpose of this disclosure, that the positioning of a portion of the surface features 38 repeats throughout the textured region 20. For example, the surface features in embodiments are arranged hexagonally.

In embodiments, the surface features 38 are not arranged in a pattern, and are positioned according to a specific but random distribution. To not be arranged in a pattern, the surface features 38 can be randomly distributed within certain constraints, such as a center-to-center distance 44 that varies but is greater than the minimum center-to-center distance 44. In addition, to not form a pattern, the longest dimension 42 of each surface feature 38 can be aligned not parallel to each other. A reason to avoid arranging the surface features 38 in a pattern is to avoid the textured region 20 generating Moiré fringe interference patterns upon reflecting ambient light. When the surface features 38 are arranged in a pattern, a possible consequence is the generation of Moiré fringe interference patterns upon reflection of ambient light.

In embodiments, the textured region 20 further includes a surrounding portion 46. The surrounding portion 46 is the portion of the textured region 20 within which the surface features 38 are disposed or from which the surface features 38 project. The surrounding portion 46 provides either (i) the one or more higher surfaces 26 or (ii) the one or more lower surfaces 32. In embodiments, where there are only two elevations from the base-plane 30 (the higher mean elevation 28 and the lower mean elevation 34), the surface features 38 provide the other of the (i) the one or more higher surfaces 26 and (ii) the one or more lower surfaces 32, whichever the surrounding portion 46 is not providing.

In embodiments, the surface features 38 are disposed within (i.e., are set into) the surrounding portion 46. In such embodiments, the surface features 38 are blind holes (“blind” meaning that surface features 38 do not go entirely through substrate 12) or depressions into the surrounding portion 46. In such embodiments, the surrounding portion 46 provides the one or more higher surfaces 26. In addition, the surface features 38 provide the one or more lower surface 32.

In contrast, in embodiments, the surface features 38 project from the surrounding portion 46. In such embodiments, the surface features 38 are pillars. In such embodiments, the surrounding portion 46 provides the one or more lower surfaces 32 of the substrate 12 residing at the lower mean elevation 34. In addition, the surface features 38 provide the one or more higher surfaces 26 of the substrate residing at the higher mean elevation 28.

When viewing a cross-section of the substrate 12 parallel with the base-plane 30 that extends through the textured region 20 and having perimeter bounded by the textured region 20, the surface features 38 each occupy a percentage of the area of the cross-section. The percentage of the area of the cross-section that the surface features 38 collectively occupy is referred to herein as the “fill-fraction” of the surface features 38. In embodiments, the fill-fraction of the surface features 38 is 40%, 41%, 42%, 43%, 44%, 45%, 46%, 47%, 48%, 49%, 50%, 51%, 52%, 53%, 54%, 55%, 56%, 57%, 58%, 59%, 60%, within a range of (e.g., 40% to 60%, 49% to 51%, and so on).

In embodiments, the surface features 38 include larger surface features 38L and smaller surface features 38S. In embodiments, the surrounding portion 46 surrounds the larger surface features 38L and at least some of the smaller surface features 38S. The “smaller” of smaller surface features 38S and the “larger” of larger surface features 38L are relative terms meaning that the smaller surface features 38S are smaller in size than the larger surface features 38L In embodiments, the longest dimension 42 of the larger surface features 38L are 30 μm, 40 μm, 50 μm, 60 μm, 70 μm, 80 μm, 90 μm, 100 μm, 110 μm, or 120 μm, or within any range bound by any two of those values (i.e., 30 μm to 120 μm, 80 μm to 110 μm, and so on). In embodiments, the longest dimension 42 of the larger surface features 38L are all about the same (e.g., the same within manufacturing tolerances). In embodiments, the longest dimension 42 of the smaller surface features 38L are 0.5 μm, 1 μm, 5 μm, 10 μm, 15 μm, 20 μm, 25 μm, or 30 μm, or within any range bound by any two of those values (i.e., 0.5 μm to 30 μm, 5 μm to 15 μm, and so on). In embodiments, the longest dimension 42 of the smaller surface features 38S are all about the same (e.g., the same within manufacturing tolerances). In embodiments, the smaller surface features 38S are more numerous than the larger surface features 38L In other words, in those embodiments, the textured region 20 includes more of the smaller surface features 38S than the larger surface features 38L.

The presence of the smaller surface features 38S has a tendency to lower pixel power deviation of the substrate 12 without increasing distinctness-of-image. Without being bound by theory, it is thought that the smaller surface features 38S “modulates” the larger surface features 38L, because the longest dimension 42 (e.g., the diameter) of the larger surface features 38L might otherwise increase pixel power deviation but the presence of the smaller surface features 38S lowers the pixel power deviation. The smaller surface features 38S are generally desirable fora relatively low pixel power deviation.

In embodiments, the minimum center-to-center distance 44 that separates each of the larger surface features 38L from each other is larger than the longest dimension 42 of the larger surface features 38L. In embodiments, the minimum center-to-center distance 44 that separates each of the larger surface features 38L is 30 μm, 40 μm, 50 μm, 60 μm, 70 μm, 80 μm, 90 μm, 100 μm, 110 μm, 120 μm, 130 μm, or within any range bound by any two of those values (e.g., 30 μm to 125 μm, and so on). In embodiments, the minimum center-to-center distance 44 that separates each of the smaller surface features 38S from each other is larger than the longest dimension 42 of the smaller surface features 38S. In embodiments, the minimum center-to-center distance 44 that separates each of the smaller surface features 38S is 1 μm, 2 μm, 3 μm, 5 μm, 10 μm, 15 μm, 20 μm, 25 μm, or 30 μm, or within any range bound by any two of those values (e.g., 1 μm to 30 μm, and so on).

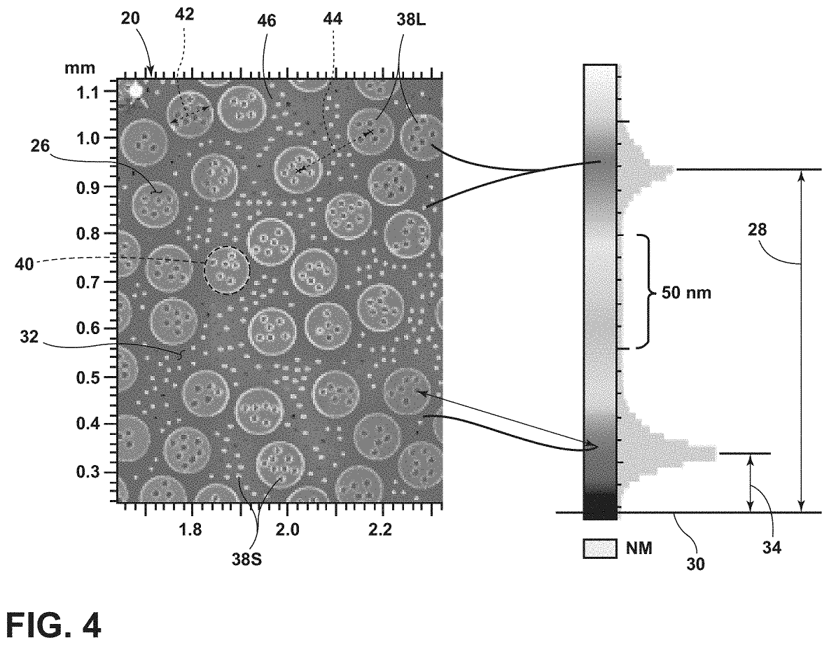

In embodiments (see e.g., FIG. 4), the smaller surface features 38S provide a portion of both (i) the one or more higher surfaces 26 and (ii) the one or more lower surfaces 32. In embodiments, some of the smaller surface features 38S are disposed within or project from the surrounding portion 46, while some of the smaller surface features 38S are set into or project from the larger surface features 38L. The smaller surface features 38S that project from either the surrounding portion 46 or project from one of the larger surface features 38L are pillars. The smaller surface features 38S that are disposed within into either the surrounding portion 46 or into one of the larger surface features 38L are blind holes.

In other embodiments, the larger surface features 38L are randomly distributed (not placed in a pattern) at the textured region 20, while the smaller surface features 38S are arranged in a pattern, such as hexogonally.

In embodiments (see e.g., FIG. 4), the larger surface features 38L project from the surrounding portion 46, some of the smaller surface features 38S project from the surrounding portion 46, and some of the smaller surface features 38S are set into the larger surface features 38L. Such a configuration can be achieved in a one-step etching process with an etching mask that protects the substrate 12 from etching (i) where the larger surface features 38L are to be projecting from the surrounding portion 46 and (ii) where the smaller surface features 38S are to be projecting from the surrounding portion 46 but allows etching of the substrate 12 (i) where the surrounding portion 46 is to be and (ii) where the smaller surface features 38S are to be set into the larger surface features 38L In such embodiments, the one or more higher surfaces 26 at the higher elevation 28 are provided by the larger surface features 38L and the smaller surface features 38S that project from the surrounding portion 46. In turn, the one or more lower surfaces 32 at the lower elevation 34 are provided by the surrounding portion 46 and the smaller surface features 38S that are set into the larger surface features 38L In embodiments (see, e.g., FIG. 4), the perimeters 40 of the larger surface features 38L do not partially overlap (only fully overlap) with the perimeters 40 of the smaller surface features 38S.

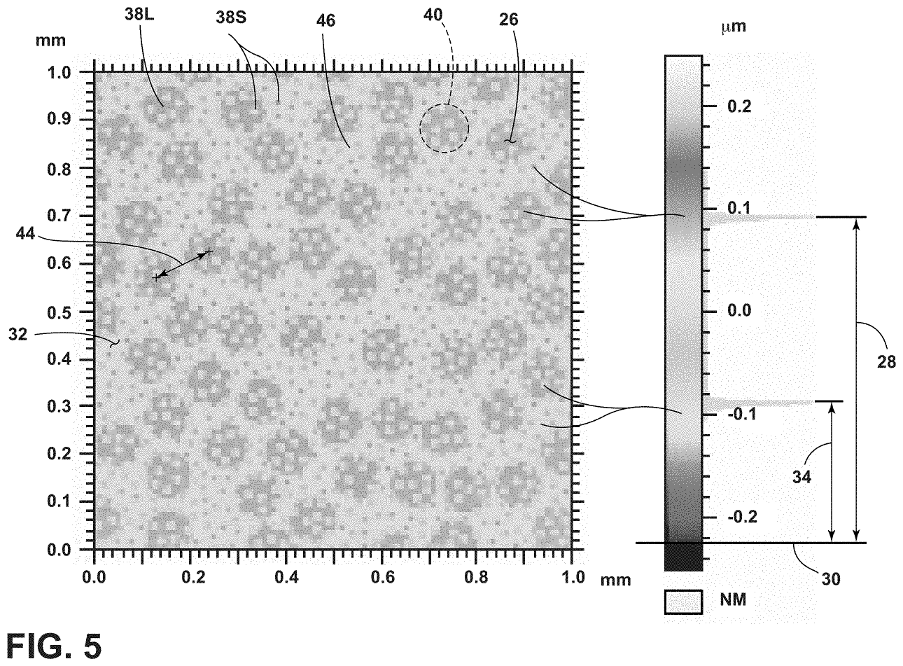

In other embodiments, such as that illustrated at FIG. 5, the perimeters 40 of the larger surface features 38L partially and fully overlap with the perimeters 40 of the smaller surface features 38S. The smaller surface features 38S that partially overlap with the larger surface features 38L provide both one or more lower surfaces 32 at the lower mean elevation 34 and one or more higher surfaces 26 at the higher elevation 28, when a one-step etching process is utilized. The embodiments of FIG. 5 are otherwise the same as the embodiments of FIG. 4.

In embodiments (not illustrated), the larger surface features 38L are set into the surrounding portion 46, some of the smaller surface features 38S project from the larger surface features 38L, and some of the smaller surface features 38S are set into the surrounding portion 46. Such a configuration can be achieved with a one-step etching process. In such embodiments, the one or more higher surfaces 26 at the higher elevation 28 are provided by the surrounding portion 46 and the smaller surface features 38S that are set into the larger surface features 38L In turn, the one or more lower surfaces 32 at the lower elevation 34 are provided by the larger surface features 38L and the smaller surface features 38S that project from the surrounding portion 46.

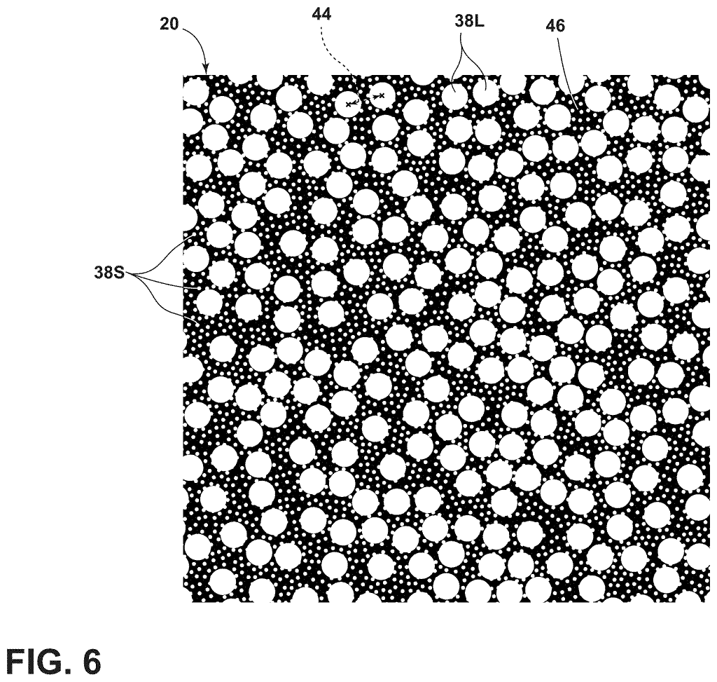

In embodiments, such as that illustrated at FIG. 6, the larger surface features 38L are set into the surrounding portion 46, while the smaller surface features 38S are set into the surrounding portion 46 as well, and none of the smaller surface features 38S are set into or project from the larger surface features 38L In such embodiments, the one or more higher surfaces 26 at the higher elevation 28 are provided by the surrounding portion 46. In turn, the one or more lower surfaces 32 at the lower elevation 34 are provided by the larger surface features 38L and the smaller surface features 38S. In embodiments (such as the inverse of embodiments illustrated at FIG. 6, not separately illustrate), the larger surface features 38L project from the surrounding portion 46, while the smaller surface features 38S project from the surrounding portion 46 as well, and none of the smaller surface features 38S are set into or project from the larger surface features 38L A one-step etching process can form such configurations.

When viewing a cross-section of the substrate 12 parallel with the base-plane 30 that extends through the textured region 20 and having perimeter bounded by the textured region 20, the larger surface features 38L and the smaller surface features 38S each occupy a percentage of the area of the cross-section. The percentage of the area of the cross-section that the larger surface features 38L collectively occupy is referred to herein as the “fill-fraction” of the larger surface features 38L. The percentage of the area of the cross-section that the smaller surface features 38S collectively occupy is referred to herein as the “fill-fraction” of the smaller surface features 38S. In embodiments, the fill-fraction of the larger surface features 38L is 20%, 25%, 30%, 35%, 40%, 45%, 50%, 55%, 60%, 65%, 70%, or within any range bounded by any two of those values (e.g., 45% to 65%, 25% to 45%, 20% to 70%, and so on). In embodiment, the fill-fraction of the smaller surface features 38S is 20%, 25%, 30%, 35%, 40%, 45%, 50%, 55%, 60%, 65%, 70%, or within any range bounded by any two of those values (e.g., 45% to 65%, 25% to 45%, 20% to 70%, and so on).

In embodiments, the textured region 20 further includes one or more surfaces 52 of the substrate 12 residing at one or more intermediate mean elevations 54a, 54b. The one or more intermediate mean elevations 54a, 54b are parallel to the base-plane 30. The one or more intermediate mean elevations 54a, 54b are less than the higher mean elevation 28 but greater than the lower mean elevation 34. The surface features 38 provide at a least a portion of (i) the one or more higher surfaces 26 residing at the higher mean elevation 28, (ii) the one or more lower surfaces 32 residing at the lower mean elevation 34, or (iii) the one or more surfaces 52 of residing atone or more intermediate mean elevations 54a, 54b.

In embodiments, the textured region 20 includes only one intermediate mean elevation 54a. Such a configuration can arise when two etching steps are utilized, and each of the two etching steps removes the same depth of material from the substrate 12. In such embodiments, the intermediate mean elevation 54a can be less than the higher mean elevation 28 by a distance of 100 nm, 125 nm, 150 nm, 175 nm, 200 nm, 225 nm, or 250 nm, or within any range bound by any two of those values (e.g., 100 nm to 250 nm, and so on). In addition, the lower mean elevation 34 is less than the higher mean elevation 28 by the distance 36 of 250 nm, 300 nm, 350 nm, 400 nm, 450 nm, or 500 nm, or within any range bound by any two of those values (e.g., 250 nm to 500 nm, and so on).

In embodiments, the textured region 20 includes two intermediate mean elevations 54a, 54b. Such a configuration can arise when two etching steps are utilized, and each of the two etching steps removes the different depths of material from the substrate 12. In such embodiments, the more elevated of the two intermediate mean elevations 54a can be less than the higher mean elevation 28 by a distance 56 of 100 nm, 110 nm, 120 nm, 130 nm, 140 nm, 150 nm, 160 nm, 170 nm, 180 nm, 190 nm, or 200 nm, or within any range bound by any two of those values (e.g., 100 nm to 200 nm, and so on). In addition, in such embodiments, the less elevated of the intermediate mean elevations 54b is less than the higher mean elevation 28 by a distance 58 of 200 nm, 210 nm, 220 nm, 230 nm, 240 nm, 250 nm, 260 nm, 270 nm, 280 nm, 290 nm, or 300 nm, or within any range bound by any two of those values (e.g., 200 nm to 300 nm, and so on). In addition, in addition, the lower mean elevation 34 is less than the higher mean elevation 28 by the distance 36 of 300 nm, 350 nm, 400 nm, 450 nm, or 500 nm, or within any range bound by any two of those values (e.g., 300 nm to 500 nm, and so on).

In embodiments, such as that illustrated at FIGS. 2 and 3, the larger surface features 38L are set into the surrounding portion 46, some of the smaller surface features 38S are set into the surrounding portion 46, and some of the smaller surface features 38S are set into the larger surface features 38L. The result is that smaller surface features 38S provide both (i) the one or more lower surfaces 42 at the lower mean elevation 34 and (i) the one or more intermediate surfaces 52 at the intermediate mean elevation 34b. The smaller surface features 38S that are set into the surrounding portion 46 provide the one or more intermediate surfaces 52 at the intermediate mean elevation 34b. The smaller surface features 38S that are set into the larger surface features 38L provide the one or more lower surfaces 42 at the lower mean elevation 34. The surrounding portion 46 provides the one or more higher surfaces 26 at the higher mean elevation 28. The larger surface features 38L are set into the surrounding portion 46 provide the one or more intermediate surfaces at the intermediate mean elevation 34a. Such a four elevation configuration is a consequence of a first etching step forming larger surface features 38L and, subsequently, a second etching step forming the smaller surface features 38S, and the two etching steps removing different depths in to the substrate.

In embodiments (not illustrated), the larger surface features 38L are set into the surrounding portion 46, some of the smaller surface features 38S project from the surrounding portion 46, and some of the plurality of smaller surface features 38S project from the plurality of larger surface features 38L. Such a configuration can be formed via two etching steps. As long as the two etching steps remove different depths of the substrate 12, the textured region 20 has the higher mean elevation 28, the lower mean elevation 34, and the two intermediate mean elevations 54a, 54b.

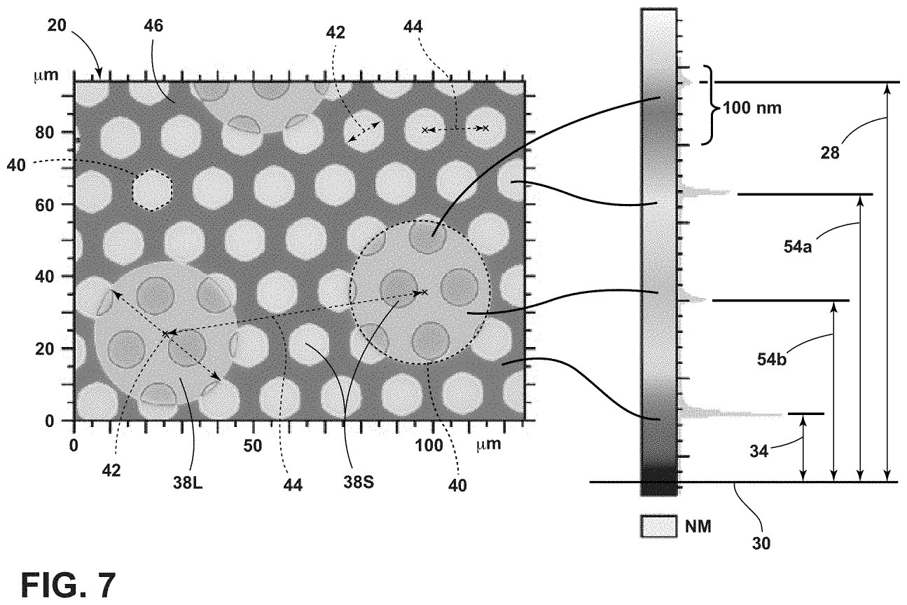

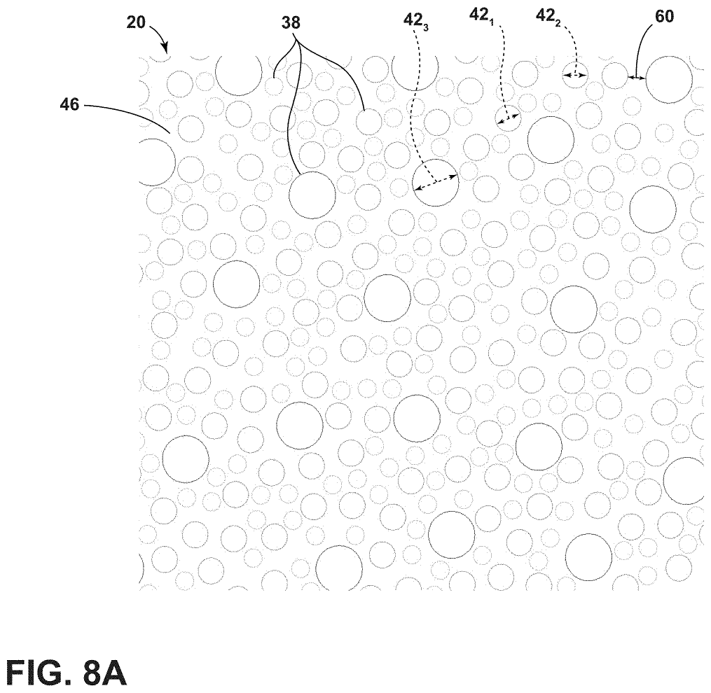

In embodiments, such as that illustrated at FIG. 7, the larger surface features 38L projected from the surrounding portion 46, some of the smaller surface features 38S project from the surrounding portion 46, and some of the smaller surface features 38S project from the larger surface features 38L In short, both the larger surface features 38L and the smaller surface features 38S are pillars. Such a configuration can be formed via two etching steps. As long as the two etching steps remove different depths of the substrate 12, the textured region 20 has the higher mean elevation 28, the lower mean elevation 34, and the two intermediate mean elevations 54a, 54b.

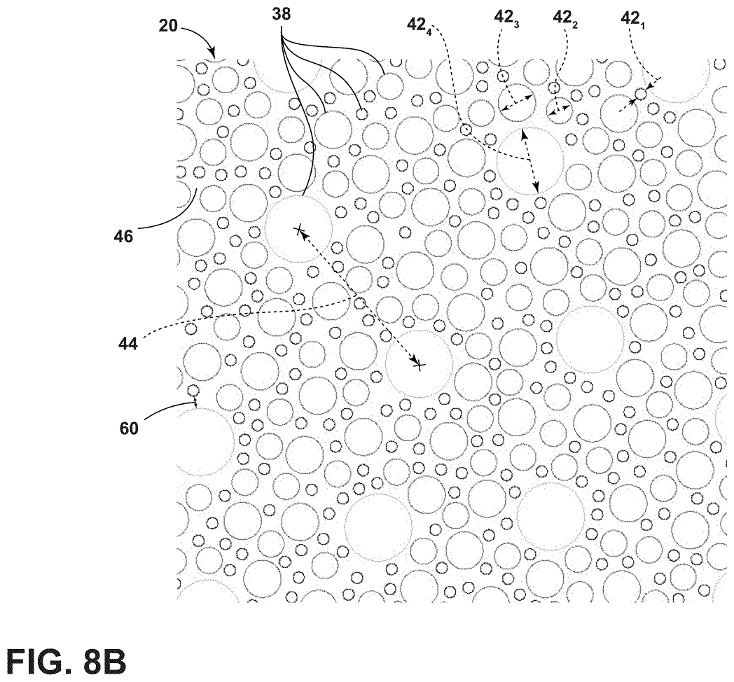

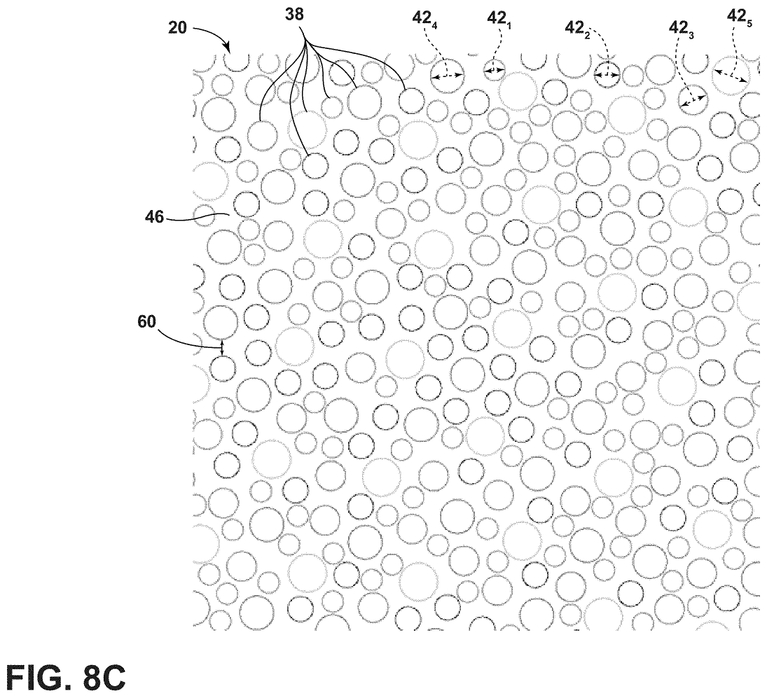

Referring now to FIGS. 8A-8C, in embodiments, the textured region 20 includes the surface features 38 projecting out of or disposed within the surrounding portion 46, and the longest dimension 42 of each surface feature 38 is one from a fixed set of longest dimensions 42₁, 42₂, 42₃, . . . 42ₙ. ranging from a smallest longest dimension 42₁ to a largest longest dimension 42ₙ. For example, in the embodiments of FIG. 8A, there are three diameters 42₁, 42₂, 42₃ in the fixed set, with diameter 42₁ being the smallest and diameter 42₃ being the largest. All of the surface features 38 are one of those three diameters 42₁, 42₂, or 42₃. In embodiments, such as illustrated at FIG. 88, there are four diameters 42₁, 42₂, 42₃, 42₄ in the fixed set, with diameter 42₁ being the smallest and diameter 42₄ being the largest. In embodiments, such as illustrated at FIG. 8C, there are five diameters 42₁, 42₂, 42₃, 42₄, 42₅ in the fixed set, with diameter 42₁ being the smallest and diameter 42₅ being the largest.

In embodiments, the minimum center-to-center distance 44 separates each of the surface features 38 with the largest diameter 42ₙ. In embodiments, a minimum distance 60 separates the surface features 38. In embodiments, the surface features 38 with the largest longest dimension 42ₙ are not arranged in a pattern. In embodiments, none of the surface features 38 with any of the fixed set of longest dimensions 42₁, 42₂, 42₃, . . . 42ₙ are arranged in a pattern. In embodiments, the fixed set of longest dimensions 42₁, 42₂, 42₃, . . . 42ₙ consist of three, four, or five longest dimensions 42. In embodiments, the longest dimensions 42ₙ of all of the fixed set of longest dimensions 42₁, 42₂, 42₃, . . . 42ₙ lie within a range of 0.5 μm to 120 μm. In addition, a minimum distance 50 from any other of the plurality of surface features 58

In embodiments where the perimeters 40 of the surface features 38 are circular and the a fixed set of longest dimensions 42₁, 42₂, 42₃, . . . 42ₙ are all diameters, the fixed set of longest dimensions 42₁, 42₂, 42₃, . . . 42ₙ can lie within a range of 6 μm to 36 μm. In such embodiments, the largest diameter 42ₙ can be within a range of 20 μm to 36 μm. In such embodiments, the minimum center-to-center distance 44 separating the surface features 38 with the largest longest dimension 42ₙ is within a range of 90 μm to 105 μm, or 90 μm to 110 μm, which appears to reduce distinctness-of-image.

When viewing a cross-section of the substrate 12 parallel with the base-plane 36 that extends through the surrounding portion 26 and having perimeter bounded by the textured region 20; the surface features 28 each occupy a percentage of the area of the cross-section. The percentage of the area of the cross-section that the surface features 28 occupy is referred to herein as the “fill-fraction” of the surface features 28. In embodiments, the fill-fraction of the surface features 58 is within a range of 40% to 60%, such as approximately 50%.

In embodiments (see, e.g., FIG. 3), the textured region 20 further includes one or more sections 48 that have secondary surface features 50. The secondary surface features 50 are smaller than the surface features 38, including smaller than the smaller surface features 38S. The secondary surface features 50 impart a surface roughness to the one or more sections 48 of the textured region 20. The increased surface roughness imparts surface scattering to the textured region 20, which generally lowers pixel power deviation and distinctness of image. The surface roughness imparted is 5 nm, 10 nm, 15 nm, 20 nm, 25 nm, 30 nm, 35 nm, 40 nm, 45 nm, 50 nm, 55 nm, 60 nm, 65 nm, 70 nm, 80 nm, 90 nm, or 100 nm or within any range bounded by any two of those values (e.g., 5 nm to 100 nm, and so on). As used herein, surface roughness (Rₐ) is measured with an atomic force microscope, such as an atomic force microscope controlled by a NanoNavi control station distributed by Seiko Instruments Inc. (Chiba, Japan), with a scan size of 5 μm by 5 μm. Surface roughness (Rₐ), as opposed to other types of surface roughness values such as R_{q}, is the arithmetical mean of the absolute values of the deviations from a mean line of the measured roughness profile.

In embodiments, the one or more sections 48 that include the secondary surface features 50 include the one or more higher surfaces 28 and the one or more lower surfaces 32. In embodiments, the secondary surface features 50 are disposed on the surface features 38 but not the surrounding portion 46. In embodiments, the secondary surface features 50 are disposed on the surrounding portion 46 but not the surface features 38. In embodiments, the secondary surface features 50 are disposed on both the surrounding portion 46 and the surface features 38. In embodiments, the one or more sections 48 that includes the secondary surface features 50 is coextensive with the textured region 20 meaning that the secondary surface features 50 are disposed throughout the entirety of the textured region 20. In embodiments, the surface roughness (Rₐ) imparted by the second surface features 50 at the surface features 38 is less than the surface roughness at the surrounding portion 46.

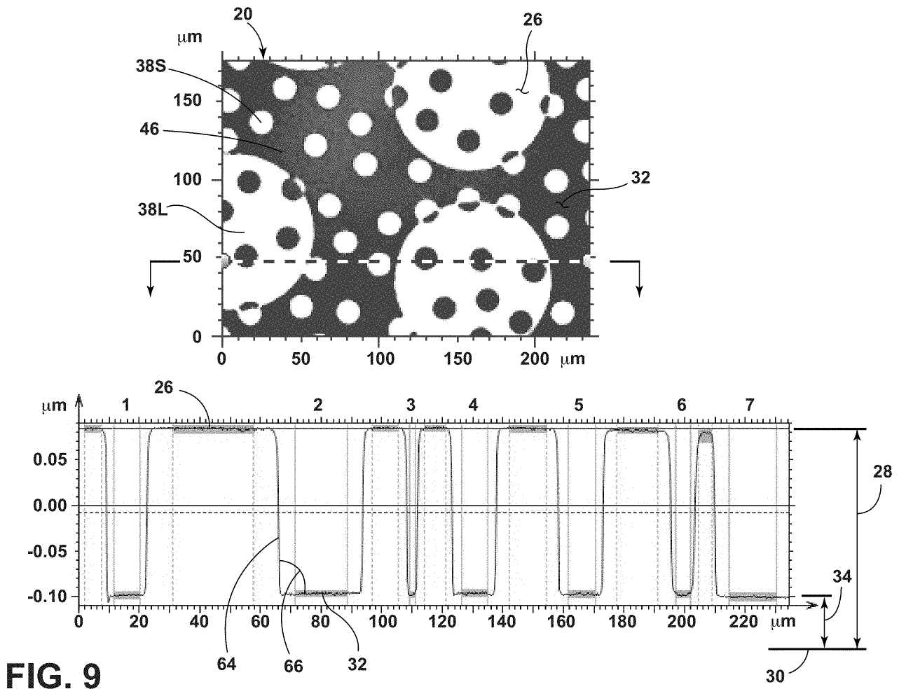

Referring now to FIG. 9, the textured region further includes sidewalls 64. The sidewalls 54 transition between the higher surfaces 26, the intermediate surfaces 52 (if present), and the lower surfaces 32. Each sidewall 64 forms an angle 66 with the intermediate surface 52 or and the lower surface 32 from which the sidewall 64 transitions toward the more elevated surface from the base-plane 30. In embodiments, the angle 66 is 80 degrees, 81 degrees, 82 degrees, 83 degrees, 84 degrees, 85 degrees, 86 degrees, 87 degrees, 88 degrees, 89 degrees, or90 degrees, or within any range bound by any two of those values (e.g., 80 degrees to 90 degrees, 85 degrees to 90 degrees, and so on).

In embodiments, the substrate 12 is a glass substrate or a glass-ceramic substrate. In embodiments, the substrate 12 is a multi-component glass composition having about 40 mol % to 80 mol % silica and a balance of one or more other constituents, e.g., alumina, calcium oxide, sodium oxide, boron oxide, etc. In some implementations, the bulk composition of the substrate 12 is selected from the group consisting of aluminosilicate glass, a borosilicate glass, and a phosphosilicate glass. In other implementations, the bulk composition of the substrate 12 is selected from the group consisting of aluminosilicate glass, a borosilicate glass, a phosphosilicate glass, a soda lime glass, an alkali aluminosilicate glass, and an alkali aluminoborosilicate glass. In further implementations, the substrate 12 is a glass-based substrate, including, but not limited to, glass-ceramic materials that comprise a glass component at about 90% or greater by weight and a ceramic component. In other implementations of the display article 10, the substrate 12 can be a polymer material, with durability and mechanical properties suitable for the development and retention of the textured region 20.

In embodiments, the substrate 12 has a bulk composition that comprises an alkali aluminosilicate glass that comprises alumina, at least one alkali metal and, in some embodiments, greater than 50 mol % SiO₂, in other embodiments, at least 58 mol % SiO₂, and in still other embodiments, at least 60 mol % SiO₂, wherein the ratio (Al₂O₃ (mol %)+B₂O₃ (mol %))/Σ alkali metal modifiers (mol %)>1, where the modifiers are alkali metal oxides. This glass, in particular embodiments, comprises, consists essentially of, or consists of: about 58 mol % to about 72 mol % SiO₂; about 9 mol % to about 17 mol % Al₂O₃; about 2 mol % to about 12 mol % B₂O₃; about 8 mol % to about 16 mol % Na₂O; and 0 mol % to about 4 mol % K₂O, wherein the ratio (Al₂O₃ (mol %)+B₂O₃ (mol %))/Σ alkali metal modifiers (mol %)>1, where the modifiers are alkali metal oxides.

In embodiments, the substrate 12 has a bulk composition that comprises an alkali aluminosilicate glass comprising, consisting essentially of, or consisting of: about 61 mol % to about 75 mol % SiO₂; about 7 mol % to about 15 mol % Al₂O₃; 0 mol % to about 12 mol % B₂O₃; about 9 mol % to about 21 mol % Na₂O; 0 mol % to about 4 mol % K₂O; 0 mol % to about 7 mol % MgO; and 0 mol % to about 3 mol % CaO.

In embodiments, the substrate 12 has a bulk composition that comprises an alkali aluminosilicate glass comprising, consisting essentially of, or consisting of: about 60 mol % to about 70 mol % SiO₂; about 6 mol % to about 14 mol % Al₂O₃; 0 mol % to about 15 mol % B₂O₃; 0 mol % to about 15 mol % Li₂O; 0 mol % to about 20 mol % Na₂O; 0 mol % to about 10 mol % K₂O; 0 mol % to about 8 mol % MgO; 0 mol % to about 10 mol % CaO; 0 mol % to about 5 mol % ZrO₂; 0 mol % to about 1 mol % SnO₂; 0 mol % to about 1 mol % CeO₂; less than about 50 ppm As₂O₃; and less than about 50 ppm Sb₂O₃; wherein 12 mol %≤Li₂O+Na₂O+K₂O≤20 mol % and 0 mol %≤MgO+Ca≤10 mol %.

In embodiments, the substrate 12 has a bulk composition that comprises an alkali aluminosilicate glass comprising, consisting essentially of, or consisting of: about 64 mol % to about 68 mol % SiO₂; about 12 mol % to about 16 mol % Na₂O; about 8 mol % to about 12 mol % Al₂O₃; 0 mol % to about 3 mol % B₂O₃; about 2 mol % to about 5 mol % K₂O; about 4 mol % to about 6 mol % MgO; and 0 mol % to about 5 mol % CaO, wherein: 66 mol %≤SiO₂+B₂O₃+CaO≤69 mol %; Na₂O+K₂O+B₂O₃+MgO+CaO+SrO>10 mol %; 5 mol % SMgO+CaO+SrO58 mol %; (Na₂O+B₂O₃)—Al₂O₃52 mol %; 2 mol %≤Na₂O—Al₂O₃56 mol %; and 4 mol %≤(Na₂O+K₂O)—Al₂O₃≤10 mol %.

In embodiments, the substrate 12 has a bulk composition that comprises Si₂, Al₂O₃, P₂O₅, and at least one alkali metal oxide (R₂O), wherein 0.75>[(P₂O₅ (mol %)+R₂O (mol %))/M₂O₃ (mol %)]≤1.2, where M₂O₃=Al₂O₃+B₂O₃. In embodiments, [(P₂O₅ (mol %)+R₂O (mol %))/M₂O₃ (mol %)]=1 and, in embodiments, the glass does not include B₂O₃ and M₂O₃=Al₂O₃. The substrate 12 comprises, in embodiments: about 40 to about 70 mol % SiO₂; 0 to about 28 mol % B₂O₃; about 0 to about 28 mol % Al₂O₃; about 1 to about 14 mol % P₂O₅; and about 12 to about 16 mol % R₂O. In some embodiments, the glass substrate comprises: about 40 to about 64 mol % SiO₂; 0 to about 8 mol % B₂O₃; about 16 to about 28 mol % Al₂O₃; about 2 to about 12 mol % P₂O₅; and about 12 to about 16 mol % R₂O. The substrate 12 may further comprise at least one alkaline earth metal oxide such as, but not limited to, MgO or CaO.

In some embodiments, the substrate 12 has a bulk composition that is substantially free of lithium; i.e., the glass comprises less than 1 mol % U₂O and, in other embodiments, less than 0.1 mol % U₂O and, in other embodiments, 0.01 mol % U₂O, and in still other embodiments, 0 mol % U₂O. In some embodiments, such glasses are free of at least one of arsenic, antimony, and barium; i.e., the glass comprises less than 1 mol % and, in other embodiments, less than 0.1 mol %, and in still other embodiments, 0 mol % of As₂O₃, Sb₂O₃, and/or BaO.

In embodiments, the substrate 12 has a bulk composition that comprises, consists essentially of or consists of a glass composition, such as Corning® Eagle XG® glass, Corning® Gorilla® glass, Corning® Gorilla® Glass 2, Corning® Gorilla® Glass 3, Corning® Gorilla® Glass 4, or Corning® Gorilla® Glass 5.

In embodiments, the substrate 12 has an ion-exchangeable glass composition that is strengthened by either chemical or thermal means that are known in the art. In embodiments, the substrate 12 is chemically strengthened by ion exchange. In that process, metal ions at or near the primary surface 18 of the substrate 12 are exchanged for larger metal ions having the same valence as the metal ions in the glass substrate. The exchange is generally carried out by contacting the substrate 12 with an ion exchange medium, such as, for example, a molten salt bath that contains the larger metal ion. The metal ions are typically monovalent metal ions, such as, for example, alkali metal ions. In one non-limiting example, chemical strengthening of a substrate 12 that contains sodium ions by ion exchange is accomplished by immersing the substrate 12 in an ion exchange bath comprising a molten potassium salt, such as potassium nitrate (KNO₃) or the like. In one particular embodiment, the ions in the surface layer of the substrate 12 contiguous with the primary surface 18 and the larger ions are monovalent alkali metal cations, such as Li⁺ (when present in the glass), Na⁺, K⁺, Rb⁺, and Cs⁺. Alternatively, monovalent cations in the surface layer of the substrate 12 may be replaced with monovalent cations other than alkali metal cations, such as Ag⁺ or the like.

In such embodiments, the replacement of small metal ions by larger metal ions in the ion exchange process creates a compressive stress region in the substrate 12 that extends from the primary surface 18 to a depth (referred to as the “depth of layer”) that is under compressive stress. This compressive stress of the substrate 12 is balanced by a tensile stress (also referred to as “central tension”) within the interior of the substrate 12. In some embodiments, the primary surface 18 of the substrate 12 described herein, when strengthened by ion exchange, has a compressive stress of at least 350 MPa, and the region under compressive stress extends to a depth, i.e., depth of layer, of at least 15 μm below the primary surface 18 into the thickness 22.

Ion exchange processes are typically carried out by immersing the substrate 12 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt, such as, but not limited to, nitrates, sulfates, and chlorides, of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments, when employed with a substrate 12 having an alkali aluminosilicate glass composition, result in a compressive stress region having a depth (depth of layer) ranging from about 10 μm up to at least 50 μm, with a compressive stress ranging from about 200 MPa up to about 800 MPa, and a central tension of less than about 100 MPa.

As the etching processes that can be employed to create the textured region 20 of the substrate 12 can remove alkali metal ions from the substrate 12 that would otherwise be replaced by a larger alkali metal ion during an ion exchange process, a preference exists for developing the compressive stress region in the display article 10 after the formation and development of the textured region 20.

In embodiments, the display article 10 exhibits a pixel power deviation (“PPD”). The details of a measurement system and image processing calculation that are used to obtain PPD values are described in U.S. Pat. No. 9,411,180 entitled “Apparatus and Method for Determining Sparkle,” the salient portions of which that are related to PPD measurements are incorporated by reference herein in their entirety. Further, unless otherwise noted, the SMS-1000 system (Display-Messtechnik & Systeme GmbH & Co. KG) is employed to generate and evaluate the PPD measurements of this disclosure. The PPD measurement system includes: a pixelated source comprising a plurality of pixels (e.g., a Lenovo Z50 140 ppi laptop), wherein each of the plurality of pixels has referenced indices i and j; and an imaging system optically disposed along an optical path originating from the pixelated source. The imaging system comprises: an imaging device disposed along the optical path and having a pixelated sensitive area comprising a second plurality of pixels, wherein each of the second plurality of pixels is referenced with indices m and n; and a diaphragm disposed on the optical path between the pixelated source and the imaging device, wherein the diaphragm has an adjustable collection angle for an image originating in the pixelated source. The image processing calculation includes: acquiring a pixelated image of the transparent sample, the pixelated image comprising a plurality of pixels; determining boundaries between adjacent pixels in the pixelated image; integrating within the boundaries to obtain an integrated energy for each source pixel in the pixelated image; and calculating a standard deviation of the integrated energy for each source pixel, wherein the standard deviation is the power per pixel dispersion. As used herein, all PPD values, attributes and limits are calculated and evaluated with a test setup employing a display device having a pixel density of 140 pixels per inch (PPI). In embodiments, the display article 10 exhibits a PPD of 1.0%, 1.2% 2.0%, 2.25%, 2.5%, 2.75%, 3.0%, 3.25%, 3.5%, 3.75%, 4.0%, 4.25%, 4.5%, 4.75%, 5.0%, 5.25%, 5.5%, 5.75%, 6.0%, 7.0%, 8.0%, 9.0%, or within any range bounded by any two of those values (e.g., 2.0% to 6.0%, and so on).

In embodiments, the substrate 12 exhibits a distinctness-of-image (“DOI”). As used herein, “DOI” is equal to 100*(Rₛ−R_{0.3*})/Rₛ, where Rₛ is the specular reflectance flux measured from incident light (at 20° from normal) directed onto the textured region 20, and R_{0.3*} is the reflectance flux measured from the same incident light at 0.2° to 0.4° from the specular reflectance flux, Rₛ. Unless otherwise noted, the DOI values and measurements reported in this disclosure are obtained according to the ASTM D5767-18, entitled “Standard Test Method for Instrumental Measurement of Distinctness-of-Image (DOI) Gloss of Coated Surfaces using a Rhopoint IQ Gloss Haze & DOI Meter” (Rhopoint Instruments Ltd.). In embodiments, the substrate exhibits a distinctness-of-image (“DOI”) of 10%, 15%, 20%, 25%, 30%, 35%, 40%, 45%, 50%, 55%, 60%, 65%, 70%, 75%, 80%, 85%, 90%, 95%, 96%, 100%, or within any range bounded by any two of those values (e.g., 10% to 96%, 35% to 60%, and so on).

In embodiments, the substrate 12 exhibits a transmission haze. As used herein, the terms “transmission haze” refers to the percentage of transmitted light scattered outside an angular cone of about ±2.5° in accordance with ASTM D1003, entitled “Standard Test Method for Haze and Luminous Transmittance of Transparent Plastics,” the contents of which are incorporated by reference herein in their entirety. Note that although the title of ASTM D1003 refers to plastics, the standard has been applied to substrates comprising a glass material as well. For an optically smooth surface, transmission haze is generally close to zero. In embodiments, the substrate 12 exhibits a transmission haze of 0.5%, 1.5%. 2%, 5%, 10%, 15%, 20%, 25%, 30%, or 35%, or within any range bounded by any two of those values (e.g., 1.5% to 25%, and so on).

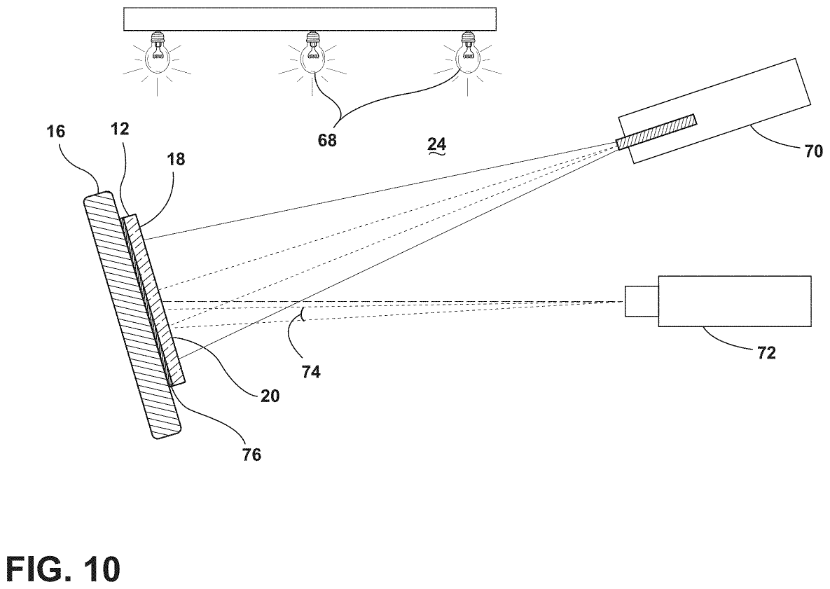

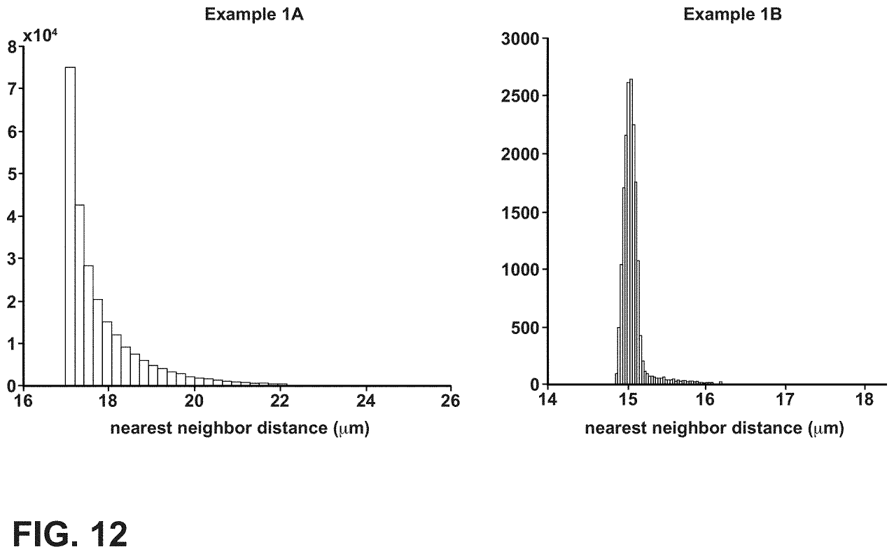

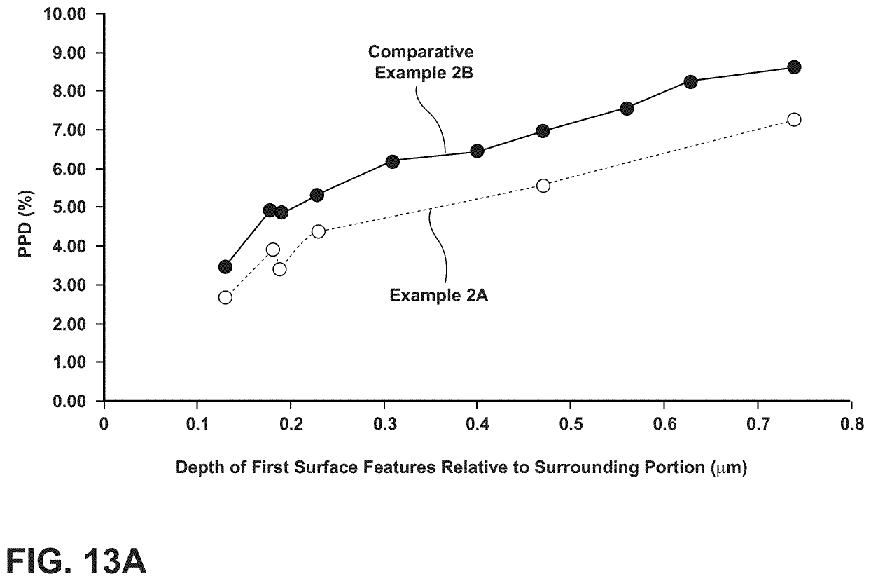

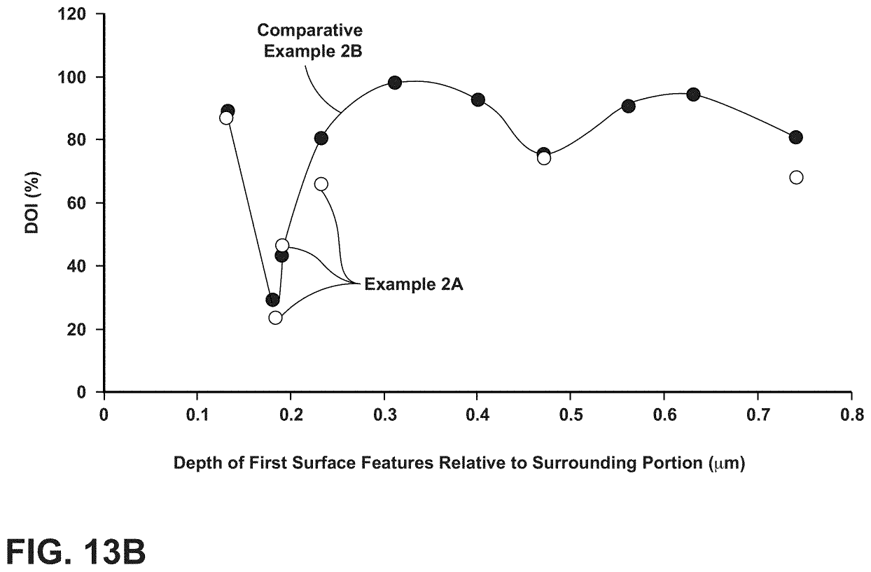

As used herein, “corrected color shift” is a measure of the amount of reflection color artifacts that the substrate 12 generates while reflecting ambient light off of the textured region 20. Referring now to FIG. 10, to determine the corrected color shift, the substrate 12 with the textured region 20 to be tested is placed over the display 16, with oil 76 disposed between the substrate 12 and the display 16 to suppress the light reflections off the back surface of the substrate 12 back surface and the surface of the display 16. The oil 76 has a refractive index matching a refractive index of the substrate 12. Room lights 68 are emitting light as they normally would. A white light source 70 illuminates the substrate 12. The textured region 20 of the substrate 12 faces toward the white light source 70. Since any reflection color artifacts that the substrate 12 generates is more easily observed and is more accurately measured when the display 16 is turned off, the display 16 is switched-off when color separation measurements are conducted. The textured region 20 reflects a portion of the light that the white light source 70 emits as a scatted light pattern (see, e.g., FIGS. 12A and 13A). A color CCD camera 72 captures an image of the scattered light pattern. The image is then digitally processed, and chromaticity coefficients (Cₓ and C_{y}) along a selected straight line through the locations with maximum Cₓ (or C_{y}) and minimum Cₓ (or C_{y}) are calculated. Here, chromaticity coefficients Cₓ and C_{y} are defined as Cₓ=P_{R}/(P_{R}+P_{G}+P_{B}) and C, =P_{G}/(P_{R}+P_{G}+P_{B}) respectively, in which P_{R}, P_{G}, P_{B} are the powers (or intensities) of red, green, and blue light, respectively, at a location of the scattered light pattern detected by the color CCD camera 72. Chromaticity is an objective specification of the quality of a color regardless of its luminance. The color shifts along the selected line, ΔCₓ and ΔC_{y}, are calculated as the difference between the maximum Cₓ and the minimum Cₓ for ΔCₓ, and the difference the maximum C_{y} and the minimum C_{y} for ΔC_{y}. The color shifts ΔCₓ and ΔC_{y} are then corrected to account for the fact that the visibility of color change that human eyes see is relative to not only the color shifts (ΔCₓ and ΔC_{y}) but also an angle separation 74 between the locations of the maximum and minimum Cₓ (for ΔCₓ) and the maximum and minimum C_{y} (for ΔC_{y}). These corrected colors shifts are defined as

$$Δ {C}_{x \_ corrected} = \frac{d {θ}_{r}}{d {θ}_{x}} Δ {C}_{x} \\ Δ {C}_{y \_ corrected} = \frac{d {θ}_{r}}{d {θ}_{y}} Δ {C}_{y}$$

The dθᵣ is reference angle separation arbitrarily set at dθᵣ=0.84 degrees. This reference angle is chosen from the angle between two adjacent measurement points of 455 point color and luminance measurement of a 300×110 mm display viewed at 500 mm distance. The dθₓ and dθ_{y} are the angle separations 74 in degree between the locations of maximum and minimum for Cₓ and C_{y} respectively. When the corrected color shifts ΔC_{x_corrected} and ΔC_{y_corrected} are each less than 0.3, it is assumed that human eyes cannot perceive any reflection color artifacts that the substrate 12 is producing. In embodiments, the substrate 12 exhibits a corrected color shifts ΔC_{x_corrected} and ΔC_{y_corrected} of 0.001, 0.01, 0.05, 0.1, 0.2, 0.3, 0.4, 0.5, 0.6, 0.7, 0.8, 0.9, 1.0, 1.2, 1.3, 1.4, 1.5, 1.6, 1.7, 1.8, 1.9, 2.0, 2.5, 3.0, 3.5, or 4.0, or within any range bounded by any two of those values (0.01 to 0.3, 0.05 to 1.0, and so on).

In embodiments, the textured region 20 simultaneously exhibits: a transmission haze within a range of 0.5% to 10%; a pixel power deviation within a range of 1.2% to 5.0%; a distinctness-of-image within a range of 40% to 100%; and exhibits corrected color shifts ΔC_{x_corrected} and ΔC_{y_corrected} that are each respectively within a range of 0.001 to 4.0. In embodiments, the textured region 20 simultaneously exhibits: a transmission haze within a range of 1.9% to 35%; a pixel power deviation within a range of 1.0% to 9.0%; a distinctness-of-image within a range of 10% to 100%; and exhibits corrected color shifts ΔC_{x_corrected} and ΔC_{y_corrected} that are each respectively within a range of 0.001 to 1.5. In embodiments, the textured region 20 simultaneously exhibits: a transmission haze within a range of 2.0% to 20%; a pixel power deviation within a range of 1.0% to 5.0%; a distinctness-of-image within a range of 50% to 100%; and exhibits corrected color shifts ΔC_{x_corrected} and ΔC_{y_corrected} that are each respectively within a range of 0.001 to 0.30.

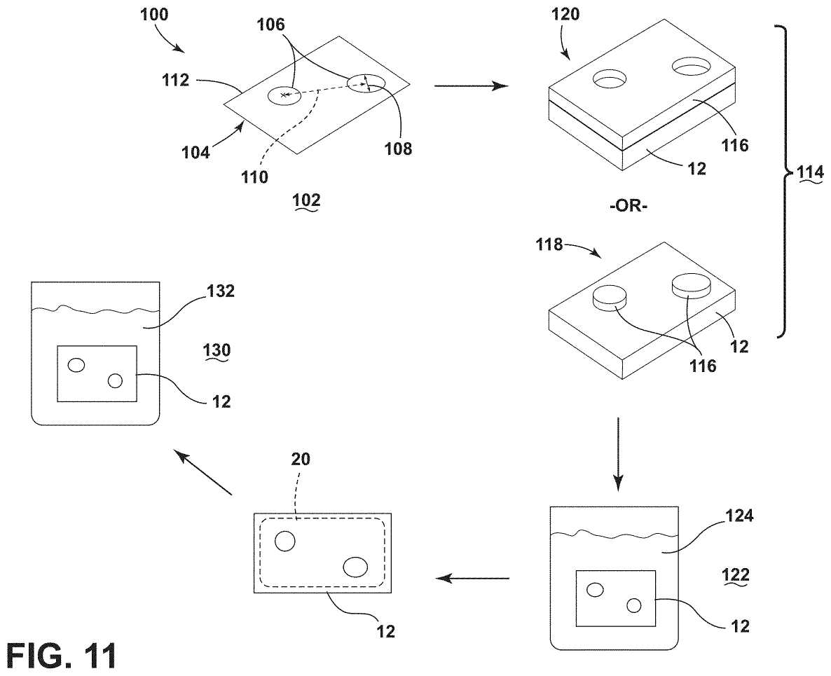

Referring now to FIG. 11, a method 100 of forming the textured region 20 is herein disclosed. At a step 102, the method 100 includes determining the positioning of the surface features 38, thus establishing the predetermined positioning of each surface feature 38. In embodiments, determining the positioning of the surface features includes forming a first design 104 in two dimensions by randomly distributing first objects 106 according to a spacing distribution algorithm, each of the first objects 106 having a longest dimension 108 (e.g., diameter) that is the same, and each of the first objects 106 are separated by a minimum center-to-center distance 110 throughout a geometrical area 112. The geometrical area 112 matches the area of the textured region 20 that is intended to be formed. The longest dimension 108 of the first objects 106 is the longest dimension 42 of the surface features 38, the longest dimension 42 of the larger surface features 38L, or the longest dimension 42ₙ (the largest of the fixed set of longest dimensions 42₁, 42₂, . . . 42ₙ), depending on which is desired.

The spacing distribution algorithm utilizes one or more of the longest dimension 42, the minimum center-to-center distance 44, and an area (matching an area which the textured region 20 will occupy) as input parameters. Example spacing distribution algorithms include Poisson disk sampling, maxi-min spacing, and hard-sphere distribution.

Poisson disk sampling inserts a first object (e.g., circular with the diameter 42) into the area. Then the algorithm inserts a second object within the area, placing the center at a random point within the area. If the placement of the second object satisfies the minimum center-to-center distance 44 from the first object, then the second object stays in the area. The algorithm then repeats this process until no more such objects can be placed within the area that satisfies the minimum center-to-center distance 44. The result is a random distribution, but specific placement, of the objects.

The maxi-min spacing algorithm is so named because it attempts to maximize the minimum nearest-neighbor center-to-center distance 34 of a point distribution. Because it proceeds iteratively, moving each object to another place where it is further from any neighbors, the algorithm usually does not achieve a perfect hexagonal lattice. It produces a random distribution with a relatively high degree of mean hexagonality, often exceeding 90%.

The hard-sphere distribution algorithm is a molecular dynamics simulation performed at finite temperature. The result is a placement of objects that differ from a hexagonal lattice. However, again, there is a higher degree of hexagonality than would result from a Poisson disk algorithm.

In embodiments desiring the textured region 20 with larger surface features 38L and smaller surface features 38S, the positioning of the larger surface features 38L can be first determined with a spacing distribution algorithm and then the positioning of the smaller surface features 38S can be determined second with a spacing distribution algorithm. The positioning of the smaller surface features 38S and the larger surface features 38L can then be superimposed to form the first design 104. Smaller surface features 38S overlapping with larger surface features 38L can be removed from the first design 104. The smaller surface features 38S that partially but not fully overlap with larger surface features 38L can be removed from the first design 104.

In embodiments desiring the textured region 20 with the fixed set of longest dimensions 42₁, 42₂, . . . 42ₙ, the positioning of each of the surface features 58 can be determined via one or more of the spacing distribution algorithms. Any of the spacing distribution algorithms mentioned herein are envisioned. For example, the maxi-min algorithm can determine the position of the surface features 38 having the largest dimension 42ₙ using a minimum center-to-center distance 106, such as 90 μm to 110 μm. Then, a spacing distribution algorithm, such as one employing a Poisson disk distribution, can determine the placement of the surface features 38 having second largest dimension 42ₙ₋₁ of the fixed set of longest dimensions 42₁, 42₂, 42₃, . . . 60ₙ, using another minimum center-to-center distance 106 and additionally a minimum distance 60 from any other of the surface features 38 already positioned. Then, a spacing distribution algorithm, such as one employing Poisson disk distribution, can determine the placement of the surface features 38 having third longest dimension 60o-2 of the fixed set of longest dimensions 42₁, 42₂, 42₃, . . . 42ₙ, using another minimum center-to-center distance 106 and additionally the minimum distance 60 from any other of the plurality of surface features 38 already positioned. This sequence repeats until all of the surface features 38, each having one of the fixed set of diameters 60₁, 60₂, 60₃, . . . 60ₙ, have been placed.

At a step 114, the method 100 further includes disposing an etching mask 116 on the primary surface 18 of the substrate 12 that either (i) prevents etching where the surface features 38 are to be formed in accordance with the predetermined positioning of the surface features 38 or (ii) allows etching only where the surface features 38 are to be formed in accordance with the predetermined positioning of the surface features 38. The etching mask 116 is a positive 118 or a negative 120 of the first design 104 so as either (i) to allow etching into the substrate 12 where the first objects 106 of the first design 104 occupy the geometrical area 112 or (ii) to deny etching into the substrate 12 where the first objects 106 occupy the geometrical area 112. In the terminology here, the negative 120 of the first design 104 allows etching into the substrate 12 where the first objects 106 of the first design 104 occupy the geometrical area 112, while the positive 118 of the first design 104 denies etching into the substrate 12 where the first objects 106 occupy the geometrical area 112. The etching mask 116 can be formed by printing curable ink onto the substrate 12 and then curing the ink, or by making a photolithography mask that incorporates the first design 104, coating the substrate 12 with curable ink, and then curing the ink with the photolithography mask on the substrate 12 over the ink. The uncured portion of the ink in then removed from the substrate leaving only the cured ink as the etching mask 116.

At a step 122, the method 100 further includes contacting the substrate 12 with an etchant 124 for a period of time while the first etching mask 116 is disposed on the primary surface 18 of the substrate 12. The step 122 thus forming the textured region 20, as discussed herein, with the (i) the one or more higher surfaces 26 of the substrate 12 residing at the higher mean elevation 28, (ii) the one or more lower surfaces 32 of the substrate 12 residing at the lower mean elevation 34, and (iii) the surface features 38.

In embodiments, the surface features 38 so formed are to be the larger surface features 38L In embodiments, the method 100 further includes repeating step 102 but this time includes determining the positioning of smaller surface features 38S, thus establishing the predetermined positioning of each the smaller surface feature. Then step 114 is repeated but this time includes disposing a second etching mask on the textured region 20 of the substrate 12 that either (i) prevents etching where the smaller surface features 38S are to be formed in accordance with the predetermined positioning of the smaller surface features 38S or (ii) allows etching only where the smaller surface features 38S are to be formed in accordance with the predetermined positioning of the smaller surface features 38S. Then step 122 is repeated but this time includes contacting the substrate 10 with an etchant 124 for a period of time while the second etching mask is disposed on the textured region 20 of the substrate 12. The textured region 20 is thus modified to include (i) the one or more surfaces 52 of the substrate 12 residing at one or more intermediate mean elevations 54a, 54b parallel to the base-plane 30, wherein the one or more intermediate mean elevations 54a, 54b are less than the higher mean elevation 28 but greater than the lower mean elevation 34, and (ii) the smaller surface features 38S. In embodiments, this second etching step removes the same depth of material from the substrate 12 as the first etching step 122. In such embodiments, the one or more surfaces 52 of the substrate reside at one intermediate mean elevation 54a. In embodiments, this second etching step removes a different depth of material from the substrate 12 than the first etching step 122. In such embodiments, the one or more surfaces 52 of the substrate 12 reside at intermediate mean elevation 54a and intermediate mean elevation 54b.

In embodiments, the etchant 124 is an HF/HNO₃ etchant. In embodiments, the etchant 124 consists of hydrofluoric acid (HF, 49 w/w %) and nitric acid (HNO₃, 69 w/w %) combinations with 0.1-5 v/v % HF and 0.1-5 v/v % HNO₃. Typical concentrations used to achieve the etching depths discussed herein are 0.1 v/v % HF/1 v/v % HNO₃ to 0.5 v/v % HF/1 v/v % HNO₃ solutions. For example, the etching step 122 can be carried out using a dip or spray etching process from room temperature to about 45° C.

At a step 130, which occurs after the step 122, the method 100 further includes forming the secondary surface features 36 into the one or more sections 34 of the textured region 20.

This step 130 increases the surface roughness (Rₐ) at the one or more sections 34 to within the range of 5 nm to 100 nm. In embodiments, the step 130 of forming the secondary surface features 36 into one or more sections 34 of the textured region 20 comprises contacting the one or more sections 34 of the textured region 20 of the substrate 12 with a second etchant 132. The second etchant 132 is different than the etchant 122 that was utilized to etch the surface features 38 into the primary surface 18 of the substrate 12. In embodiments, the second etchant 132 includes acetic acid and ammonium fluoride. In embodiments, the second etchant 132 includes (in wt %): 85 to 98 acetic acid, 0.5 to 7.5 ammonium fluoride, and 0 to 11 water. The water can be deionized water. In embodiments, the second etchant 132 contacts the one or more sections 34 for a time period within a range of 15 seconds to 5 minutes. In embodiments, the second etchant 132 contacts the one or more sections 34 while the etching mask 116 used to form the surface features 38 remains on the substrate 12. This would result in the increase of the surface roughness (Rₐ) of only the surface features 38 and not the surrounding portion 46, or only the surrounding portion 46 and not the primary surface features 38. After the period of time has concluded the substrate 12 is rinsed with deionized water and dried. Both etching steps 122, 130 can be conducted at room temperature.

### EXAMPLES

Examples 1A and 1B—For Examples 1A and 1B, and in reference to FIG. 11, two different spacing distribution algorithms were utilized to position a plurality of surface features within a textured region of a defined surface area. More specifically, for Example 1A, a Poisson disk distribution algorithm was utilized to position objects (representing the plurality of second surface features to-be) having a diameter of 12 μm with a minimum center-to-center spacing of 17 μm. For Example 1B, a maxi-min spacing algorithm was utilized to position objects (representing the plurality of second surface features to-be) having a diameter of 12 μm with a minimum center-to-center spacing of about 14.8 μm. The number of occurrences for the actual spacing between nearest of the objects positioned via each of the two algorithms were recorded and graphed. FIG. 11 shows the graphs for each algorithm. As a comparison of the graph for Example 1A versus the graph of Example 1B reveals the Poisson disk distribution contains a broader range of actual center-to-center distances between nearest circular objects. The maxi-min spacing algorithm results in a tighter nearest neighbor distance histogram and positioning much closer to a hexagonal lattice (higher average hexagonality.)

Example 2A and Comparative Example 2B—These examples are in reference to FIGS. 13A and 13B. For both Example 2A and Comparative Example 2B, larger surface features were set into a surrounding portion via a first etching step, using a variety of depths from the surrounding portion. The depths of the plurality of first surface features from the surrounding portion ranged from 0.13 μm (130 nm) to about 0.75 μm (750 nm). The larger surface features had a diameter of 50 μm. The larger surface features were separated by minimum center-to-center distance of 60 μm. For Example 2A, a second etching step added smaller surface features, with some of the smaller surface features set into the surrounding portion and some of the smaller surface features set into the larger surface features. The smaller surface features had a diameter of 12 μm. The smaller surface features had a minimum center-to-center distance of 17 μm and were arranged in a hexagonal lattice. The Comparative Example 2B was not subjected to a second etching step.

The pixel power deviation and the distinctiveness-of-image were then measured for the samples of each of the examples. The results were recorded and graphed. The graphs comparing the results of Example 2A with the results of Comparative Example 2B are set forth at FIGS. 13A and 13B.

A comparison of the results reveals that the inclusion of the smaller surface features in Example 2A lowered the pixel power deviation of the samples of Example 2A for any given depth of the larger first surface features compared to the samples of Comparative Example 2B. See FIG. 13A. In addition, the inclusion of the smaller surface features in the samples of Example 2A had relatively little impact or slightly lowered the distinctiveness-of-image compared to the samples of Comparative Example 2B. See FIG. 13B.

Example 3—For Example 3, and in reference to FIG. 2, a substrate was subjected to a first etching step with a first etching mask to form larger surface features set into a surrounding portion. The larger surface features had a diameter of 50 μm. The larger surface features had a minimum-center-to-center distance of 60 μm. The larger features had a depth from the surrounding portion of 170 nm. The substrate with the larger surface features was then subjected to a second etching step with a second etching mask to form smaller surface features. Some of the smaller surface feature were set into the larger surface features, while some of the smaller surface features were set into the surrounding portion. The smaller surface features had a diameter of 12 μm and a minimum center-to-center spacing of 17 μm. The second etching step went about 170 nm deep. Thus, the smaller surface features set into the surrounding portion had a depth from the surrounding portion of 250 nm. The smaller surface features set into the surrounding portion had a depth from the larger surface features of 250 nm, and a depth from the surrounding portion of 420 nm. The surrounding portion, the plurality of first surface features, and the plurality of second surface features formed a textured region with four different elevations from a base-plane through a thickness of the substrate.

Examples 4A-4C—For each of Examples 4A-4C, a substrate was subjected to a first etching step with a first mask to form a larger surface features set into a surrounding portion. The substrate was then subjected to a second etching step with a second mask to smaller surface features. Some of smaller surface features were set into the surrounding portion, while some of the smaller surface features were set into the larger surface features. The positioning of each of the larger surface features was randomly distributed pursuant to a hard sphere spacing distribution algorithm. The positioning of each of the smaller surface features was randomly distributed pursuant to a hard sphere spacing distribution algorithm for Examples 4A and 48 and pursuant to a Poisson disk algorithm for Example 4C. The diameters (“Diameter 1^{st}” and “Diameter 2^{nd}”), minimum center-to-center distances (“Min C-to-C 1^{st}” and “Min C-to-C 2^{nd}”), and fill- (“FF 1^{st}” and “FF 2^{nd}”) for both the larger surface features and the smaller surface features are set forth in Table 1 below. In addition, ranges for the depth of etching (i.e., how deep into the thickness the etching was allowed to occur) for both the first etching step (“Etch Depth 1^{st}”) and the second etching step (“Etch Depth 2^{nd}”) are provided in the Table 1 below. Various anti-glare performance metrics were measured for all samples. More specifically, the transmission haze (“haze”), the pixel-power deviation (“PPD”), the distinctiveness-of-image (“DOI”), and corrected color shifts ΔC_{x_corrected} and ΔC_{y_corrected} were measured and recorded. The results are set forth in Table 1 below. The surrounding portion, the plurality of first surface features, and the plurality of second surface features formed a textured region with four different elevations from a base-plane through a thickness of the substrate.

TABLE 1

| | Diameter 1^{st} | Min C-to-C 1^{st} | FF 1^{st} | Depth 1^{st} |
|---|---|---|---|---|
| Example | (μm) | (μm) | (%) | (μm) |
| 4A | 40 | 50 | 50 | 0.18 |
| 4B | 40 | 50 | 50 | 0.16 |
| 4C | 50 | 60 | 35 | 0.19 |
| | Diameter 2^{nd} | Min C-to-C 2^{nd} | FF 2^{nd} | Depth 2^{nd} |
| Example | (μm) | (μm) | (%) | (μm) |
| 4A | 12 | 14 | 50 | 0.37 |
| 4B | 12 | 14 | 50 | 0.46 |
| 4C | 15 | 25 | 45 | 0.19 |

| | Haze | | | | |
|---|---|---|---|---|---|
| Example | (%) | PPD | DOI | ΔCₓ_{_{—}}_{corrected} | ΔC_{y}_{_{—}}_{corrected} |
| 4A | 12.4 | 3.59 | 28 | 1.185 | 1.101 |
| 4B | 19 | 3.29 | 25 | 1.2 | 1.1 |
| 4C | 5.02 | 4.78 | 29 | 0.673 | 0.662 |

Analysis of the results reveals that the substrates of the two examples have usable anti-glare performance metrics with a transmission haze of under 20%, a pixel-power deviation of less than 5, a distinctiveness-of-image of under 30%, and corrected color values of under 1.5.

Examples 5A-5E—Each of the rows in Table 2 summarily describe a collection of samples, corresponding to example designs 5A-5E. All samples were subjected to a first etching step with a first etching mask to form a larger surface features set into a surrounding portion. All of the samples were then subjected to a second etching step with a second etching mask to form smaller surface features. Some of the plurality of second surface features were set into the surrounding portion, while some of the plurality of second surface features were set into the plurality of first surface features (thus forming blind-holes inside blind-holes). The positioning of the larger first surface features and the smaller surface features were randomly distributed pursuant to one of the spacing distribution algorithms mentioned herein, either Poisson disk, maxi-min, or hard sphere. The diameter (“Diameter 1^{st}”), minimum center-to-center spacing (“Min C-to-C 1^{st}”), and range of fill-fractions (“FF 1^{st}”) for the larger surface features, and the ranges of the etching depths for the first etching step (“Depth 1^{st}”) are set forth in Table 2 below. The diameter (“Diameter 2^{nd}”), minimum center-to-center spacing (“Min C-to-C 2^{nd}”), and range of fill-fractions (“FF 2^{nd}”) for the smaller surface features, and the ranges of the etching depths for the second etching step (“Depth 1^{st}”) are set forth in Table 2 below. Various anti-glare performance metrics were measured for all samples. More specifically, the transmission haze (“haze”), the pixel-power deviation (“PPD”), the distinctiveness-of-image (“DOI”), and corrected color shifts ΔC_{x_corrected} and ΔC_{y_corrected} were measured and recorded. The results are set forth in Table 2 below. Note that where Table 2 reports a single value for a corrected color shift, only data for one sample was obtained.

TABLE 2

| | Diameter 1^{st} | Min C-to-C 1^{st} | FF 1^{st} | Depth 1^{st} |
|---|---|---|---|---|
| Example | (μm) | (μm) | (%) | (μm) |
| 5A | 40 | 50 | 46-51 | 0.31-0.44 |
| 5B | 50 | 60 | 36 | 0.13-0.20 |
| 5C | 50 | 60 | 36 | 0.16-0.21 |
| 5D | 50 | 60 | 45-52 | 0.11-0.25 |
| 5E | 50 | 60 | 36-49 | 0.11-0.18 |
| | Diameter 2^{nd} | Min C-to-C 2^{nd} | FF 2^{nd} | Depth 2^{nd} |
| Example | (μm) | (μm) | (%) | (μm) |
| 5A | 12 | 14 | 53-63 | 0.06-0.33 |
| 5B | 15 | 17 | 29-36 | 0.11-0.27 |
| 5C | 15 | 25 | 26-36 | 0.11-0.27 |
| 5D | 20 | 25 | 45-54 | 0.12-0.27 |
| 5E | 12 | 14 | 31-66 | 0.16-0.52 |

| | Haze | | | | |
|---|---|---|---|---|---|
| Example | (%) | PPD | DOI | ΔCₓ_{_{—}}_{corrected} | ΔC_{y}_{_{—}}_{corrected} |
| 5A | 11.6-14 | 2.4-2.7 | 81-93 | 1.2 | 1.1 |
| 5B | 2.1-11.1 | 4.1-5.1 | 29-57 | 0.673 | 0.662 |
| 5C | 1.9-6.9 | 5.0-5.5 | 32-69 | 0.649 | 0.515 |
| 5D | 3.3-11 | 3.1-4.7 | 11-95 | 0.29 | 0.34-1.23 |
| 5E | 5-23 | 2.7-3.7 | 22-80 | 1.14 | 0.8 |

Examples 6A-6C—Each of the rows in Table 3 summarily describe a collection of samples, corresponding to example designs 6A-6E. All samples share in common the features (i) that the larger surface features were randomly distributed pursuant to a spacing distribution algorithm and (ii) the smaller surface features were distributed in a hexagonal lattice, as illustrated in FIG. 7. For the samples of Examples 6A and 6C, a first etching step formed the larger surface features set into the surrounding portion, while a second etching step formed the smaller surface features with some projecting from the surrounding portion and some projecting from the larger surface features. For the samples of Examples 6B, a first etching step formed the larger surface features projecting from the surrounding portion, and a second etching step formed the smaller surface features with some projecting from the surrounding portion and some projecting from the larger surface features. The diameters (“Diameter 1^{st}” and “Diameter 2^{nd}”), minimum center-to-center distances (“Min C-to-C 1^{st}” and “Min C-to-C 2^{nd}”), and fill- (“FF 1^{st}” and “FF 2^{nd}”) for both the larger surface features and the smaller surface features are set forth in Table 3 below. In addition, ranges for the depth of etching (i.e., how deep into the thickness the etching was allowed to occur) for both the first etching step (“Etch Depth 1^{st}”) and the second etching step (“Etch Depth 2^{nd}”) are provided in the Table 3 below. Various anti-glare performance metrics were measured for all samples. More specifically, the transmission haze (“haze”), the pixel-power deviation (“PPD”), the distinctiveness-of-image (“DOI”), and corrected color shifts ΔC_{x_corrected} and ΔC_{y_corrected} were measured and recorded. The results are set forth in Table 3 below. Note that where Table 3 reports a single value for a corrected color shift, only data for one sample was obtained.

TABLE 3

| | Diameter 1^{st} | Min C-to-C 1^{st} | FF 1^{st} | Etch Depth 1^{st} |
|---|---|---|---|---|
| Example | (μm) | (μm) | (%) | (μm) |
| 6A | 50 | 60 | 34-38 | 0.13-0.82 |
| 6B | 40 | 60 | 23 | 0.13-0.19 |
| 6C | 40 | 60 | 23 | 0.14-0.88 |

| | Diameter 2^{nd} | Min C-to-C 2^{nd} | FF 2^{nd} | Etch Depth 2^{nd} |
|---|---|---|---|---|
| Example | (μm) | (μm) | (%) | (μm) |
| 6A | 12 | 17 | 28-53 | 0.04-0.66 |
| 6B | 12 | 17 | 37-50 | 0.17-0.29 |
| 6C | 12 | 17 | 38-61 | 0.20-0.24 |

| | Haze | | | | |
|---|---|---|---|---|---|
| Example | (%) | PPD | DOI | ΔCₓ_{_{—}}_{corrected} | ΔC_{y}_{_{—}}_{corrected} |
| 6A | 6.4-33 | 1.3-7.3 | 20-87 | 0.94 | 0.79 |
| 6B | 7.0-10.4 | 2.3-3.4 | 76-87 | — | — |
| 6C | 7.7-13.5 | 3.1-8.3 | 39-81 | — | — |

Examples 7A-7C—These examples all again share in common the features (i) that the larger surface features were randomly distributed pursuant to a spacing distribution algorithm (specifically the hard sphere spacing distribution algorithm) and (ii) the smaller surface features were distributed in a hexagonal lattice, as illustrated in FIG. 7. For each of the examples, a first etching step was utilized to form the larger surface features to project from the surrounding portion. A second etching step was utilized to form the smaller surface features, with some of the smaller surface features projecting from the surrounding portion and some of the smaller surface features set into the larger surface features.

The diameters (“Diameter 1^{st}” and “Diameter 2^{nd}”), minimum center-to-center distances (“Min C-to-C 1^{st}” and “Min C-to-C 2^{nd}”), and fill- (“FF 1^{st}” and “FF 2^{nd}”) for both the larger surface features and the smaller surface features are set forth in Table 4 below. In addition, ranges for the depth of etching (i.e., how deep into the thickness the etching was allowed to occur) for both the first etching step (“Etch Depth 1^{st}”) and the second etching step (“Etch Depth 2^{nd}”) are provided in the Table 4 below. Various anti-glare performance metrics were measured for all samples. More specifically, the transmission haze (“haze”), the pixel-power deviation (“PPD”), the distinctiveness-of-image (“DOI”), and corrected color shifts ΔC_{x_corrected} and ΔC_{y_corrected} were measured and recorded. The results are set forth in Table 4 below.

TABLE 4

| | Diameter 1^{st} | Min C-to-C 1^{st} | FF 1^{st} | Etch Depth 1^{st} |
|---|---|---|---|---|
| Example | (μm) | (μm) | (%) | (μm) |
| 7A | 50 | 60 | 50 | 0.15 |
| 7B | 50 | 60 | 50 | 0.16 |
| 7C | 50 | 60 | 50 | 0.15 |

| | Diameter 2^{nd} | Min C-to-C 2^{nd} | FF 2^{nd} | Etch Depth 2^{nd} |
|---|---|---|---|---|
| Example | (μm) | (μm) | (%) | (μm) |
| 7A | 12 | 17 | 50 | 0.36 |
| 7B | 12 | 17 | 50 | 0.66 |
| 7C | 12 | 17 | 50 | 0.04 |

| | Haze | | | | |
|---|---|---|---|---|---|
| Example | (%) | PPD | DOI | ΔCₓ_{_{—}}_{corrected} | ΔC_{y}_{_{—}}_{corrected} |
| 7A | 10.6 | 2.17 | 20 | 0.944 | 0.792 |
| 7B | 20.5 | 1.52 | 43 | 0.95 | 0.8 |
| 7C | 13.9 | 2.24 | 42 | 0.95 | 0.8 |

Analysis of the measured anti-glare attributes demonstrates that the textured region of the substrates of the Examples 7A-7C reflects diffusely with the DOI values under 50% but still transmits light well from the display with the haze values under 21% or even under 15% in several cases. The PPD values under 3 are acceptable, and the corrected color shift values under 1.0 reveal low reflected color artifacts.

Examples 8A-8D—For all of Examples 8A-8D, a single etching step was utilized to form the larger surface features and the smaller second surface features. For Examples 8A and 88, the larger surface features were set into the surrounding portion, while some of the smaller surface features projected from the larger surface features and some of the smaller surface features were set into the surrounding portion. Example 88 is a summary of samples. For Examples 8C and 8D, the larger surface features projected from the surrounding portion, while some of the smaller surface features were set into the larger surface features and some of the smaller surface features projected from the surrounding portion. Example 8D is a summary of samples. For all of the Examples 8A-8D, a random distribution spacing algorithm was utilized to set the positions of the larger surface features and the smaller surface features. More specifically, for Examples 8A and 8C, a Poisson disk algorithm was utilized. For all of the Examples 8A-8D, none of the smaller surface features intersected with a perimeter of any of the larger surface features—i.e., none of the smaller surface features partially overlapped with any of the larger surface features. In other words, any of the smaller surface features that would have partially but not fully overlapped with any of the larger surface features were removed from the design from which the etching mask was formed.

The diameters (“Diameter 1^{st}” and “Diameter 2^{nd}”) and minimum center-to-center distances (“Min C-to-C 1^{st}” and “Min C-to-C 2^{nd}”) for both the larger surface features and the smaller surface features are set forth in Table 5 below. The fill-factor (“FF”) of larger surface features and the smaller surface features combined is additionally included. Further, ranges for the depth of etching (i.e., how deep into the thickness the etching was allowed to occur) for the single etching step (“Etch Depth”) are provided in the Table 5 below. Various anti-glare performance metrics were measured for all samples. More specifically, the transmission haze (“haze”), the pixel-power deviation (“PPD”), the distinctiveness-of-image (“DOI”), and corrected color shifts ΔC_{x_corrected} and ΔC_{y_corrected} were measured and recorded. The results are set forth in Table 5 below.

TABLE 5

| | Diameter 1^{st} | Min C-to-C 1^{st} | FF | Etch Depth |
|---|---|---|---|---|
| Example | (μm) | (μm) | (%) | (μm) |
| 8A | 100 | 110 | 50 | 0.17 |
| 8B | 50 | 90 | 50 | 0.12-0.37 |
| 8C | 100 | 110 | 50 | 0.16 |
| 8D | 100 | 110 | 50 | 0.08-0.11 |

| | Diameter 2^{nd} | Min C-to-C 2^{nd} |
|---|---|---|
| Example | (μm) | (μm) |
| 8A | 10 | 20 |
| 8B | 16 | 19 |
| 8C | 10 | 20 |
| 8D | 10 | 20 |

| | Haze | | | | |
|---|---|---|---|---|---|
| Example | (%) | PPD | DOI | ΔCₓ_{_{—}}_{corrected} | ΔC_{y}_{_{—}}_{corrected} |
| 8A | 0.51 | 1.42 | 61.85 | 0.558 | 0.579 |
| 8B | 1.5-8.9 | 1.8-4.7 | 61-99 | 0.33-0.34 | 0.25-0.26 |
| 8C | 2.03 | 1.08 | 52.5 | 0.086 | 0.113 |
| 8D | 0.51-2.0 | 1.4-3.9 | 53-100 | 0.09-3.7 | 0.11-0.31 |

Analysis of the measured anti-glare attributes demonstrates that the textured region of the substrates of the Examples 8A and 8C in particular produced outstanding results with transmitting light from the display with a transmission haze of only 0.51% and 2.03%, respectively, and a pixel power deviation of under 1.5%, but somewhat adequately diffusely reflected ambient light (DOI of 61.85% and 52.5% respectively) and did so with little or no perceivable reflected color artifacts (both ΔC_{x_corrected} and ΔC_{y_corrected} were around 0.6 for Example 8A and well under 0.3 for Example 8C, meaning that a user could not perceive reflected color artifacts).

Examples 9A-9H—For these examples, a single etching step was utilized to form the larger surface features set into the surrounding portion, while the smaller surface features are set into the surrounding portion as well, and none of the smaller surface features are set into or project from the larger surface features. For all of the Examples 9A-9H, the placement of both the larger surface features and the smaller surface features were randomly distributed pursuant to a spacing distribution algorithm. For Example 9A-9D, a Poisson disk algorithm determined placement of the larger surface features. For the placement of smaller surface features, a maxi-min algorithm was utilized for Examples 9A and 9C, and a Poisson disk algorithm was utilized for Examples 9B and 9D. Examples 9E-9H are summary examples that included more than one sample.

The diameters (“Diameter 1^{st}” and “Diameter 2^{nd}”), minimum center-to-center distances (“Min C-to-C 1^{st}” and “Min C-to-C 2^{nd}”), and fill- (“FF 1^{st}” and “FF 2^{nd}”) for both the larger surface features and the smaller surface features are set forth in Table 6 below. In addition, ranges for the depth of etching (i.e., how deep into the thickness the etching was allowed to occur) for the single etching step (“Etch Depth”) are provided in the Table 6 below. Various anti-glare performance metrics were measured for all samples. More specifically, the transmission haze (“haze”), the pixel-power deviation (“PPD”), the distinctiveness-of-image (“DOI”), and corrected color shifts ΔC_{x_corrected} and ΔC_{y_corrected} were measured and recorded. The results are set forth in Table 6 below.

TABLE 6

| | Diameter 1^{st} | Min C-to-C 1^{st} | FF 1^{st} | Etch Depth |
|---|---|---|---|---|
| Example | (μm) | (μm) | (%) | (μm) |
| 9A | 100 | 110 | 44.7 | 0.15 |
| 9B | 90 | 110 | 36 | 0.14 |
| 9C | 90 | 110 | 36 | 0.16 |
| 9D | 100 | 110 | 44.7 | 0.16 |
| 9E | 90 | 110 | 36 | 0.12-0.18 |
| 9F | 90 | 110 | 36 | 0.12-0.16 |
| 9G | 100 | 110 | 44.7 | 0.12-0.18 |
| 9H | 100 | 110 | 44.7 | 0.12-0.16 |

| | Diameter 2^{nd} | Min C-to-C 2^{nd} | FF 2^{nd} |
|---|---|---|---|
| Example | (μm) | (μm) | (%) |
| 9A | 20 | 25 | 50 |
| 9B | 15 | 25 | 19.8 |
| 9C | 20 | 25 | 50 |
| 9D | 15 | 25 | 19.8 |
| 9E | 20 | 25 | 50 |
| 9F | 15 | 25 | 19.8 |
| 9G | 15 | 25 | 19.8 |
| 9H | 20 | 25 | 50 |

| | Haze | | | | |
|---|---|---|---|---|---|
| Example | (%) | PPD | DOI | ΔCₓ_{_{—}}_{corrected} | ΔC_{y}_{_{—}}_{corrected} |
| 9A | 1.7 | 2.57 | 72.52 | 0.58 | 0.58 |
| 9B | 1.35 | 1.96 | 40.34 | 0.078 | 0.095 |
| 9C | 2.02 | 2.3 | 59.42 | 0.433 | 0.387 |
| 9D | 1.45 | 2.52 | 51.7 | 1.564 | 1.440 |
| 9E | 1.1-4.1 | 1.9-2.9 | 54-81 | 0.43-0.90 | 0.39-1.62 |
| 9F | 0.9-1.7 | 1.8-2.6 | 51-66 | 0.08-0.44 | 0.10-0.39 |
| 9G | 1.3-2.0 | 2.5-3.5 | 51-77 | 0.75-1.7 | 0.72-1.5 |
| 9H | 1.1-2.1 | 2.3-3.7 | 64-85 | 0.24-0.58 | 0.31-0.58 |

Analysis of the measured anti-glare attributes demonstrates that the textured region of the of Example 9B in particular transmits light from the display with very little transmittance haze (1.35%) and low pixel power deviation (under 2.096), while diffusely reflecting ambient light (DOI of 40.34%) and doing so with imperceptible reflected color artifacts (corrected color shifts under 0.10).

Examples 10A-10F—For Examples 10A-10F, a single etching step formed surface features set into the surrounding portion, each of the surface features having one of a fixed set of diameters. Examples 10E and 10F are summary examples.

The number of diameters in the fixed set of diameters (“Number of Diameters”), etch depth for the single etching step (“etch depth”), and the fill-fraction of the plurality of surface features (“FF”) are set forth in Table 7 below. Various anti-glare performance metrics were measured for all samples. More specifically, the transmission haze (“haze”), the pixel-power deviation (“PPD”), the distinctiveness-of-image (“DOI”), and corrected color shifts ΔC_{x_corrected} and ΔC_{y_corrected} were measured and recorded. The results are set forth in Table 7 below.

TABLE 7

| | Number of | Etch Depth | FF |
|---|---|---|---|
| Example | Diameters | (μm) | (%) |
| 10A | 3 | 0.16 | 50 |
| 10B | 3 | 0.16 | 50 |
| 10C | 4 | 0.13 | 50 |
| 10D | 4 | 0.14 | 50 |
| 10E | 3 | 0.13-0.46 | 50 |
| 10F | 4 | 0.13-0.43 | 50 |

| | Haze | | | | |
|---|---|---|---|---|---|
| Example | (%) | PPD | DOI | ΔCₓ_{_{—}}_{corrected} | ΔC_{y}_{_{—}}_{corrected} |
| 10A | 3.22 | 1.81 | 55 | 0.203 | 0.154 |
| 10B | 5.58 | 1.69 | 64.84 | 0.199 | 0.167 |
| 10C | 3.93 | 1.08 | 84.0 | 0.14 | 0.12 |
| 10D | 26.5 | 1.19 | 64.7 | 0.143 | 0.128 |
| 10E | 2.3-18.0 | 1.6-4.8 | 55-99 | 0.2-0.27 | 0.15-0.21 |
| 10F | 2.7-23 | 1.2-3.6 | 64-99 | 0.11-0.16 | 0.12-0.15 |

Analysis of the measured anti-glare attributes demonstrates that the textured region of the substrate of the Examples 10A in particular transmits light from the display with little transmittance haze (under 4%) and low pixel power deviation (under 2.0), while somewhat diffusely reflecting ambient light (DOI of 55%) and doing so with unperceivable reflected color artifacts (corrected color shift values of 0.203 and 0.154).

Examples 11A and 11B—For Examples 11A and 11B, two samples of a substrate were subjected to a two-step etching process. After a first etching step, larger surface features projected from a surrounding portion. After a second etching step, smaller surface features were set into both the larger surface features and the surrounding portion.

The diameters (“Diameter 1^{st}” and “Diameter 2^{nd}”) and minimum center-to-center distances (“Min C-to-C 1^{st}” and “Min C-to-C 2^{nd}”) for both the plurality of first surface features and the plurality of second surface features are set forth in Table 8 below. The depth of etching for the first etching step (“Etch Depth 1^{st}”) and the fill-fraction (“FF 1^{st}”) for the plurality of first surface features are provided as well.

TABLE 8

| | Diameter 1^{st} | Min C-to-C 1^{st} | FF 1^{st} | Etch Depth 1^{st} |
|---|---|---|---|---|
| Example | (μm) | (μm) | (%) | (μm) |
| 11A | 50 | 90 | 44 | 0.15 |
| 11B | 100 | 110 | 44 | 0.15 |

| | Diameter 2^{nd} | Min C-to-C 2^{nd} |
|---|---|---|
| Example | (μm) | (μm) |
| 11A | 16 | 19 |
| 11B | 10 | 20 |

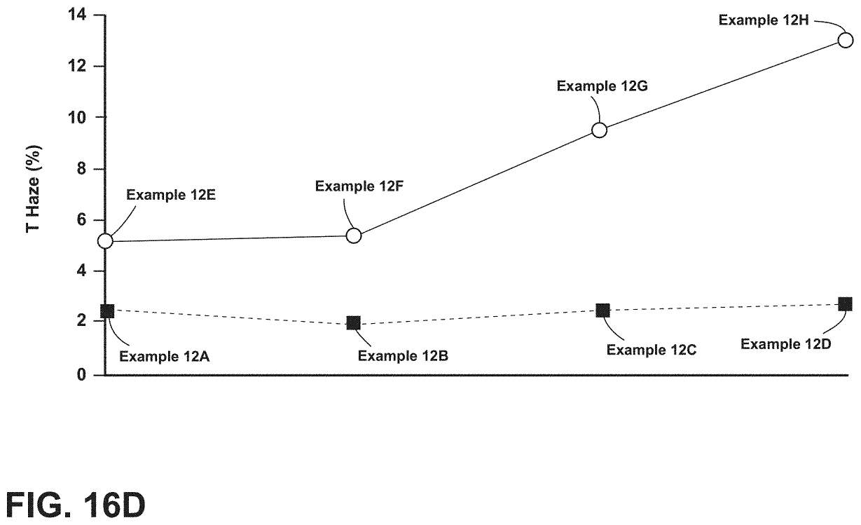

The color shifts of Examples 11A and 11B were determined using the testing set up illustrated at FIG. 10. The textured surface of each of the substrate of Examples 11A and 11B reflected a portion of the white light from the white light source as a scatted light pattern. Images of the scattered light pattern that each substrate generated are reproduced at FIGS. 14A (for Example 11A) and 15A (for Example 11B). Because the intensities (or powers) of red, blue, and green wavelengths are encoded in the images captured by the CCD, intensities (or powers) of red, blue, and green wavelengths as a function of position along a cross-section of the scattered light pattern could be extracted out for each example. Graphs charting the results are reproduced at FIGS. 148 (for Example 11A) and 15B (for Example 11B). Chromaticity coefficients (Cₓ and C_{y}) as a function of position along a cross-section of the scattered light pattern were then determined for each example from the intensity of red, blue, and green wavelengths data. Graphs charting the results are reproduced at FIGS. 14C (for Example 11A) and 15C (for Example 11B). For Example 11A, the color shift ΔCₓ, defined as C_{x_max}−C_{x_min}, is 0.328. For Example 11A, the color shift ΔC_{y}, defined as C_{y_max}−C_{y_min}, is 0.182. For Example 11B, the color shift ΔCₓ is 0.399 and the color shift ΔC_{y} is 0.229.

The color shifts for both examples, if uncorrected, are similar. However, according to the study of human perception, the scattered light pattern that Example 11B generates is more visible to a viewer than the scattered light pattern that Example 11A generates. That is because the color shifts in the scattered light pattern of Example 11B are more tightly packed than in the scattered light pattern of Example 11A. The colored rings that Example 11B generates as illustrated at FIG. 14A are narrower than the colored rings that Example 11A generates as illustrated at FIG. 3A. As explained above, these color shifts can be corrected to account for the distance (or angle separation) through which the color shifts occur. When corrected in such a manner, the corrected color shifts ΔC_{x_corrected} and ΔC_{y_corrected} for Example 11A are 0.299 and 0.147, respectively. In turn, the corrected color shifts ΔC_{x_corrected} and ΔC_{y_corrected} for Example 11B are 2.854 and 1.228, respectively. Table 9 below summarizes.

TABLE 9

| | | | Color ring Width | | | |
|---|---|---|---|---|---|---|
| | Color Shift | | (degree) | | Corrected Color Shift | |
| Example | ΔCₓ | ΔC_{y} | dθₓ | dθ_{y} | ΔCₓ_{_{—}}_{corrected} | ΔC_{y}_{_{—}}_{corrected} |
| Example 11A | 0.328 | 0.182 | 0.92 | 1.04 | 0.299 | 0.147 |
| Example 11B | 0.399 | 0.229 | 0.12 | 0.16 | 2.854 | 1.228 |

Examples 12A-12H—For each of Examples 12A-12H, a glass substrate was obtained having dimensions of 4 mm by 4 mm by 0.7 mm. The glass substrate was then subjected to a first etching step to etch surface features set into a surrounding portion, generating a textured region where the surface features provided surfaces residing at a higher mean elevation and surface features providing surfaces residing at a lower mean elevation. Each surface feature had a perimeter that was circular. The diameter of the perimeter was 40 μm. An etching mask was utilized to place each of the surface features. The placement of each of the surface features was generated using a spacing distribution algorithm. The spacing distribution algorithm required a minimum center-to-center distance between circles of 50 μm. The placement of the surface features pursuant to the spacing distribution algorithm was thus randomized and did not form a pattern. The placement of the surface features made pursuant to the spacing distribution algorithm was transferred to a lithograph mask, which was then used to cure AZ 4210 lithography ink disposed on the primary surface of the substrate. The uncured portions of the lithograph ink was removed and the cured portion remained as the etching mask. The surface features occupied about 50% of the area of the textured region, and the depth of the surface features was 0.18 μm. Four of the samples were then set aside as Example 12A-12D and not subjected to a second etching step to add secondary surface features that added surface roughness.

The remaining four samples were assigned to be Examples 12E-12H and each subjected to a second etching step using an etchant including acetic acid, ammonium fluoride, and water (deionized). The etchant for Examples 12E and 12F had a composition of 92 wt % acetic acid, 2 wt % ammonium fluoride, and 6 wt % water (deionized). The second etching step for Examples 12E and 12F formed secondary surface features that imparted a surface roughness (Rₐ) of ˜28 nm. The etchant for Examples 12G and 12H had a composition of 90 wt % acetic acid, 1 wt % ammonium fluoride, and 9 wt % water (deionized). In each of Examples 12E-12H, the etchant contacted the sample of a time period of 2 minutes. The second etching step for Examples 12G and 12H formed secondary surface features that imparted a surface roughness (Rₐ) of ˜54 nm.

Referring now to FIGS. 15A-15D, the pixel power deviation (FIG. 16A), the specular reflectance (FIG. 168), the distinctness-of-image (FIG. 16C), and the transmission haze (FIG. 16D) were measured for each example. The measurements are set forth in the aforementioned graphs at FIGS. 16A-16D. Analysis of the graphs reveal that the second etching step that formed the secondary surface features that added surface roughness to the textured region resulted in a lowering of pixel power deviation and distinctness-of-image but resulted in increasing the transmission haze. The higher surface roughness that the secondary surface features imparted to Examples 12G and 12H compared to Examples 12E and 12F did not affect the values for the distinctness-of-image (see FIG. 16C). However, the higher surface roughness that the secondary surface features imparted to Examples 12G and 12H did result in smaller pixel power deviation values compared to Examples 12E and 12F (see FIG. 16A) but with higher transmission haze values (see FIG. 16D). The addition of the secondary surface features did not appear to affect measured specular reflectance (see FIG. 168).

What is claimed is:

1. A substrate for a display article, the substrate comprising:
a primary surface; and
a textured region defined on the primary surface, the textured region comprising:
one or more higher surfaces residing at a higher mean elevation parallel to a base-plane disposed below the textured region extending through the substrate;
one or more lower surfaces residing at a lower mean elevation parallel to the base-plane, wherein the lower mean elevation is less than the higher mean elevation; and
surface features providing at a least a portion of either the one or more higher surfaces residing at the higher mean elevation or the one or more lower surfaces residing at the lower mean elevation, each surface feature comprising a perimeter that is parallel to the base-plane and that has a longest dimension.

2. The substrate of claim 1, wherein
the lower mean elevation differs from the higher mean elevation by a distance within a range of 50 nm to 700 nm.

3. The substrate of claim 1, wherein
the longest dimensions of the surface features are within a range of 0.5 μm to 120 μm.

4. The substrate of claim 1, wherein
the surface features are not arranged in a pattern.

5. The substrate of claim 1,
wherein, the textured region further comprises:
a surrounding portion providing either (i) the one or more higher surfaces or (ii) the one or more lower surfaces;
wherein, the surface features provide the other of the (i) the one or more higher surfaces and (ii) the one or more lower surfaces, whichever the surrounding portion is not providing.

6. The substrate of claim 5, wherein
the surface features are disposed within the surrounding portion, and provide the one or more lower surfaces; and
the surrounding portion provides the one or more higher surfaces.

7. The substrate of claim 5, wherein
the surface features project from the surrounding portion, and provide the one or more higher surfaces of the substrate residing at the higher mean elevation; and
the surrounding portion provides the one or more lower surfaces of the substrate residing at the lower mean elevation.

8. The substrate of claim 1, wherein
a fill-fraction of the surface features is within a range of 40% to 60%.

9. The substrate of claim 1, wherein
the surface features comprise larger surface features and smaller surface features,
the longest dimension of the larger surface features are all about the same and are within a range of 30 μm to 120 μm,
the longest dimension of the smaller surface features are all about the same, are smaller than the longest dimension of the larger surface features, and are within a range of 0.5 μm to 30 μm, and
the smaller surface features are more numerous than the larger surface features.

10. The substrate of claim 9, wherein
each of the larger surface features are separated from each other by a minimum center-to-center distance that (i) is larger than the longest dimension of the larger surface features and (ii) within a range of 30 μm to 125 μm; and
each of the smaller surface features are separated by a minimum center-to-center distance that (i) is larger than the longest dimension of the smaller surface features and (ii) within a range of 1 μm to 30 μm.

11. The substrate of claim 9, wherein
the smaller surface features provide a portion of both (i) the one or more higher surfaces and (ii) the one or more lower surfaces.

12. The substrate of claim 9, wherein
the perimeters of the larger surface features do not overlap with the perimeters of the smaller surface features.

13. The substrate of claim 9, wherein
the perimeters of the larger surface features overlap with the perimeters of the smaller surface features.

14. The substrate of claim 9, wherein
a fill-fraction of the larger surface features is 20% to 70%; and
a fill-fraction of the smaller surface features is within a range of 20% to 70%.

15. The substrate of claim 9, wherein
the textured region exhibits a transmission haze within a range of 0.5% to 10%;
the textured region exhibits a pixel power deviation within a range of 1.2% to 5.0%;
the textured region exhibits a distinctness-of-image within a range of 40% to 100%; and
the textured region exhibits corrected color shifts ΔC_{x_corrected} and ΔC_{y_corrected} that are each respectively within a range of 0.001 to 4.0.

16. The substrate of claim 1, wherein
the textured region further comprises one or more sections comprising secondary surface features imparting a surface roughness (Rₐ) within a range of 5 nm to 100 nm.

17. The substrate of claim 1, wherein
the perimeter of each of the surface features is circular, and the longest dimension is the diameter.

18. The substrate of claim 1, wherein
the substrate comprises a glass substrate or a glass-ceramic substrate.

19. A substrate for a display article, the substrate comprising:
a primary surface; and
a textured region defined on the primary surface, the textured region comprising:
one or more higher surfaces of a substrate residing at a higher mean elevation parallel to a base-plane disposed below the textured region extending through the substrate;
one or more lower surfaces of the substrate residing at a lower mean elevation parallel to the base-plane, wherein the lower mean elevation is less than the higher mean elevation;
one or more surfaces of the substrate residing at one or more intermediate mean elevations parallel to the base-plane, wherein the one or more intermediate mean elevations are less than the higher mean elevation but greater than the lower mean elevation; and
surface features providing at a least a portion of (i) the one or more higher surfaces residing at the higher mean elevation, (ii) the one or more lower surfaces residing at the lower mean elevation, or (iii) the one or more surfaces of the substrate residing at one or more intermediate mean elevations,
wherein, each surface feature comprises a perimeter and has a longest dimension parallel to the base-plane,
wherein, the surface features comprise larger surface features and smaller surface features, and
wherein, the longest dimensions of the smaller surface features are smaller than the longest dimensions of the larger surface features.

20. A substrate for a display article, the substrate comprising:
a primary surface; and
a textured region defined on the primary surface, the textured region comprising:
one or more higher surfaces residing at a higher mean elevation parallel to a base-plane disposed below the textured region and extending through the substrate;
one or more lower surfaces residing at a lower mean elevation parallel to the base-plane, wherein the lower mean elevation is less than the higher mean elevation;
a surrounding portion providing either (i) the one or more higher surfaces residing at the higher mean elevation or (ii) the one or more lower surfaces of the substrate residing at the lower mean elevation; and
surface features, each having a perimeter that is parallel to the base-plane, projecting out of or disposed with a surrounding portion, wherein each surface feature comprises a longest dimension from a fixed set of longest dimensions ranging from a smallest longest dimension to a largest longest dimension.
